(19) United States
(12) Patent Application Publication
(10) Pub. No.: US 2024/0349945 A1
(43) Pub. Date: Oct. 24, 2024

(54) ASYMMETRIC BLENDER CUP AND MOTOR BASE SIPPING MECHANISM

(71) Applicant: VITA-MIX MANAGEMENT CORPORATION, Olmsted Twonship, OH (US)

(72) Inventors: Casey Zale, Olmsted Township, OH (US); Davis J. Kolar, Stow, OH (US); Rebecca Hammond, Rocky River, OH (US); Saifur Tareen, Sadsworth, OH (US)

(73) Assignee: VITA-MIX MANAGEMENT CORPORATION, Olmsted Township, OH (US)

(21) Appl. No.: 18/686,194

(22) PCT Filed: Aug. 29, 2022
(86) PCT No.: PCT/US2022/041838

§ 371 Date: Feb. 23, 2024

Related U.S. Application Data
(60) Provisional application No. 63/237,803, filed on Aug. 27, 2021.
(60) Provisional application No. 63/249,305, filed on Sep. 28, 2021.
(60) Provisional application No. 63/271,776, filed on Oct. 26, 2021.

(51) Int. Cl. A47J 43/042; A47J 43/046

(52) U.S. Cl. CPC A47J 43/042; A47J 43/046

(57) ABSTRACT

Provided is a blending system comprising a cup and a motor base. The motor base may include a sipping mechanism and a plug that operatively opens and closes access to the sipping mechanism. In a closed position, the plug may seal the sipping pathway at or near the internal wall and at or near the external wall. In an open position, the plug may insert into a plug receptacle adjacent the sipping pathway. The plug receptacle and sipping pathway may be sealed from contents of the cup in a closed position. The electrical components of the motor base, such as one or more of the motor, battery, drive shaft, and blade assembly, may be offset from a central axis of the motor base to accommodate the sipping mechanism. The blending system may be portable.

### CROSS REFERENCE TO RELATED APPLICATIONS

This application claims priority to U.S. Patent Application No. 63/237,803, filed on Aug. 27, 2021, entitled “Blender Cup and Motor Base Sipping Mechanism,” claims priority to U.S. Patent Application No. 63/249,305, filed on Sep. 28, 2021, entitled “Blender Cup and Motor Base Sipping Mechanism,” and claims priority to U.S. Patent Application No. 63/271,776, filed on Oct. 26, 2021, entitled “Asymmetric Blender Cup And Motor Base Sipping Mechanism,” which are all incorporated herein by reference.

### TECHNICAL FIELD

The present teachings relate to a blending system, and more particularly to a motor base comprising a sipping mechanism and a motor base with an asymmetric orientation of mixing and/or electrical components.

### BACKGROUND

Blenders and blending systems are often used to blend and process foodstuffs. Conventional blenders generally include a base with a motor and a mixing container with an operable mixing blade disposed therein. A blender lid is adapted to cover the container. A user inserts contents within the mixing container to be mixed by the rotation of the blade. The container is positioned on the base as a user controls the operation of the motor within the base to rotate the mixing blade within the container to mix the contents therein. The contents are then transferred from the container to a personal cup or bottle. Such large format blending systems may not be suitable for all applications. Smaller and more portable blender cups may be used for certain applications.

Frozen, frosty, or icy drinks have become increasingly popular. Such drinks include the traditional shakes, and the more recently popular smoothies. Shakes, or milkshakes, are typically formed of ice cream and/or milk, and flavored as desired, with or without additives, such as candies, chocolates, peanut butter, fruits, etc. Milkshakes typically are available at most fast-food restaurants, such as burger chains, and may be made by special machines, or hand-made using mixers. Smoothies tend to be healthier, and may be formed of ice, frozen yogurt, and/or sorbet. Smoothies may include additives such as fruits, fruit juice, vegetables, vitamins, supplements, etc. Smoothies typically are available from specialty chains or juice bars, and may be made with a commercial or restaurant-grade blender. Such drinks also may be made at home, using a personal blender. Soups, salsas, sauces, purees, nut or oat milks, and the like, may also be made using a blender or blending systems.

Current blending systems generally require a container that is attachable to a motor housing at a closed end and that is used for blending of foodstuff, this container being separate from a cup that is used to deliver or consume the blended product. This type of blending system also generally require a lid to cover the open end of the container during blending, and can be bulky or not easily portable. Other current blending systems may require a container that is attachable to a motor housing at an open end, but these require that the container be detached or removed from the motor housing prior to consumption or transfer of the blending foodstuff there.

There is a need for improved blender systems that may be portable and configured to allow access to and consumption of the blended product within a blending cup while the motor housing is attached to the blending cup, without having to first removing or detaching the blending cup from the motor housing. Further, there it may be desirable to improve blending cups and blender systems to allow for easy and quick consumption of the blended product after blending and easier cleaning of the blending cup.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a blending system having a sipping mechanism. The blending system may include a blending container and a motor base. The blending container may have an open end and a closed end and the motor base may be selectively attachable to the open end of the blending container. The motor base may include an internal wall that faces or inserts into the open end of the blending container and an external wall that faces away from the blending container. The motor base may further include a blade assembly on the internal wall. The motor base may further include a sipping pathway that extends from the external wall and to the internal wall and that may allow access to an interior of the blending container when the motor base is selectively attached to the open end of the blending container. The motor base may further include a plug that selectively opens and closes the sipping pathway to allow selective access to or sealing of the interior of the blending container when the motor base is selectively attached to the open end of the blending container. The blending system may be portable.

Disclosed is a blender. The blender may comprise a housing and a cup with a closed end and an open end. In an embodiment, the housing may comprise a motor. The cup may be attachable to the housing at the open end of the cup. The housing may comprise an external wall, an internal wall, and at least one sidewall. The motor may be disposed between the external wall and the internal wall and within the at least one sidewall. A surface of the internal wall may include a mixing blade extending therefrom and coupled to the motor through a drive shaft. The housing may comprise a sipping pathway extending from the internal wall to the external wall. The housing may comprise an elongated plug extending from the internal wall to the external wall and operatively sealing the sipping pathway when in a closed position and allowing flow of material through the sipping pathway when in an open position.

In an embodiment, the plug may comprise one or more tracks or rails to engage with the housing and to transition between the closed position and the open position. In an embodiment, the plug may be slidable from a first position on an outer circumference of the housing to a second position on the outer circumference of the housing to transition between the closed position and the open position. In an embodiment, the plug may be rotatable about an axis defined by the sipping pathway to transition between the closed position and the open position. In an embodiment, the internal wall may cover at least a portion of the plug when the plug is in the open position. In an embodiment, the plug may insert into a plug receptacle in the housing in the open position. In an embodiment, the plug receptacle may be sealed from the cup in the closed position.

In an embodiment, the plug may comprise a tab extending from plug wherein force applied to the tab moves the plug from the closed position and the open position. In an embodiment, the housing may comprise an apron that extends from the at least one side wall at or near the external wall. In an embodiment, the apron may attach with the open end of the cup.

In an embodiment, the housing may comprise a battery disposed between the external wall and the internal wall and within the at least one sidewall. In an embodiment, at least one of the battery, the mixing blade, the drive shaft, and the motor may be offset from a central axis of the housing, wherein the central axis is defined by the internal wall and the external wall.

In an embodiment, the blender may comprise at least one magnet pair in the housing to bias the plug towards the closed position. In an embodiment, the plug may be removable from the housing. In an embodiment, an exterior surface of the exterior wall may comprise a user interface that receives input to operatively control operation of the motor and blade assembly.

Disclosed is a blender. The blender may comprise a cup with a closed end and an open end. The blender may comprise a motor housing comprising an interior end that is insertable into the open end of the cup and a sipping pathway extending through the motor housing to an exterior end. The blender may comprise a plug that may operatively close the sipping pathway at both the interior end and the exterior end of the motor housing. The motor housing may comprise a motor disposed in the motor housing and may include a mixing blade on the interior end, wherein the mixing blade may be coupled to the motor through a drive shaft. The mixing blade, the drive shaft, and the motor may be offset from a central axis of the motor housing.

In an embodiment, the motor housing may comprise a battery. In an embodiment, the battery may be offset from the central axis of the motor housing. In an embodiment, the plug may comprise a hinged top closure and a hinged bottom closure to transition between a closed position and an open position. In an embodiment, the hinged top closure and hinged bottom closure may be linked so that transitioning the hinged top closure to the open position may cause the hinged bottom closure to open and transitioning the hinged top closure to the closed position may cause the hinged bottom closure to close.

Disclosed is a blender. The blender may comprise a cup with a closed end and an open end, and a motor housing with an interior end and an exterior end, wherein the interior end may be insertable into the open end of the cup and wherein the exterior end may be attachable to the open end of the cup. The motor housing may comprise a motor and a battery disposed within the motor housing. The motor housing may comprise a mixing blade on the interior end and coupled to the motor through a drive shaft. The mixing blade, the drive shaft, the battery, and the motor may be offset from a central axis of the motor housing. The motor housing may comprise a sipping pathway extending from the internal end to the external end and a plug. The plug may be operatively moveable between a closed position within the sipping pathway and an open position within a cavity of the motor housing.

In an embodiment, the blender may further comprise a first at least one sensor that detects the presence of the cup in an attached position. In an embodiment, the blender may further comprise a second at least one sensor that detects the presence of the plug in at least the closed position. In an embodiment, the blender may further comprise a drive circuit that prevents operation of the motor when the first at least one sensor does not detect the cup in the attached position or the second at least one sensor does not detect the plug in the closed position. In an embodiment, the cavity of the motor housing may be sealed from the cup when the plug is in the closed position. In an embodiment, the plug may comprise a tab to facilitate transition between the open position and the closed position. In an embodiment, the plug may be removable from the motor housing.

Disclosed is a blender. The blender may be a cup blender and allow for both blending of foodstuff and consumption of blended foodstuff in the same cup or system. The base may include a body having a top, a bottom, and a side. A blade assembly may extend from the top. The blade assembly may be driven by a motor that is powered by a power source. The power source and the motor may be disposed within the body. The power source may be disposed next to or adjacent the motor. The motor may have a motor axis coaxial with a drive shaft. The body may have a body axis. The motor axis may be offset with the body axis. The circumference of the body may be reduced. The top may include an angled surface. A protrusion may extend from the angled surface. The blade assembly may extend from the protrusion. An attachment mechanism may be provided that allows for quick connection and detachment between the cup and the base.

### DESCRIPTION OF THE DRAWINGS

The present teachings may be better understood by reference to the following detailed description taken in connection with the following illustrations, wherein:

FIG. 1 is a perspective bottom view of an embodiment of a blending system in accordance with various disclosed aspects herein:

FIGS. 2A-B are perspective top views of an embodiment of a first blending system in a closed position and an open position in accordance with various disclosed aspects herein:

FIGS. 3A-B are top plan views of an embodiment of the first blending system shown in FIGS. 2A-B in a closed position and an open position in accordance with various disclosed aspects herein:

FIGS. 4A-B are cross-sectional views of an embodiment of the first blending system in FIGS. 2A-B in a closed position and an open position in accordance with various disclosed aspects herein:

FIG. 5 is a perspective top view of an embodiment of a first plug in accordance with various disclosed aspects herein:

FIGS. 6A-B are perspective top views of an embodiment of a second blending system in a closed position and an open position in accordance with various disclosed aspects herein:

FIG. 7 is a perspective top view of an embodiment of a second plug in accordance with various disclosed aspects herein:

FIGS. 8A-B are perspective top views of an embodiment of a third blending system in a closed position and an open position in accordance with various disclosed aspects herein:

FIGS. 9A-B are top plan views of an embodiment of the third blending system shown in FIGS. 8A-B in a closed position and an open position in accordance with various disclosed aspects herein:

FIGS. 10A-B are cross-sectional views of an embodiment of the third blending system shown in FIGS. 8A-B in a closed position and an open position in accordance with various disclosed aspects herein:

FIG. 11 is a perspective top view of an embodiment of a third plug in accordance with various disclosed aspects herein:

FIGS. 12A-B are perspective top views of an embodiment of a fourth blending system in a closed position and an open position in accordance with various disclosed aspects herein;

FIG. 13 is a perspective top view of an embodiment of a fourth plug in accordance with various disclosed aspects herein;

FIGS. 14A-B are perspective top views of an embodiment of a fifth blending system in a closed position and an open position in accordance with various disclosed aspects herein:

FIGS. 15A-B are top plan views of an embodiment of the fifth blending system shown in FIGS. 14A-B in a closed position and an open position in accordance with various disclosed aspects herein:

FIGS. 16A-B are cross-sectional views of an embodiment of the fifth blending system in FIGS. 14A-B in a closed position and an open position in accordance with various disclosed aspects herein;

FIG. 17 is a perspective top view of an embodiment of a fifth plug in accordance with various disclosed aspects herein;

FIG. 18 is a cross-sectional view of an embodiment of a sixth blending system in a closed position in accordance with various disclosed aspects herein:

FIG. 19 is a detailed cross-sectional view of an embodiment of the sixth blending system in FIG. 18 in a closed position in accordance with various disclosed aspects herein:

FIG. 20 is a cross-sectional view of an embodiment of a seventh blending system in a closed position in accordance with various disclosed aspects herein:

FIGS. 21A-B are cross-sectional views of an embodiment of the eighth blending system in a closed position and an open position in accordance with various disclosed aspects herein:

FIGS. 22A-B are perspective top views of an embodiment of a eighth blending system in a closed position and an open position in accordance with various disclosed aspects herein:

FIGS. 23A-B are perspective bottom views of an embodiment of a eighth blending system in a closed position in accordance with various disclosed aspects herein:

FIGS. 24A-B are detailed views of an embodiment of an eighth blending system in accordance with various disclosed aspects herein:

FIG. 25 is a cross-sectional view of an embodiment of a ninth blending system in a closed position in accordance with various disclosed aspects herein:

FIGS. 26A-B are top views of an embodiment of a ninth blending system with the tube inserted and removed in accordance with various disclosed aspects herein:

FIG. 27 is a partial cross-sectional view of an embodiment of a cup blender in accordance with various disclosed aspects herein:

FIG. 28 is a partial cross-sectional view of an embodiment of a cup blender including an offset drive shaft of a motor in accordance with various disclosed aspects herein:

FIG. 29 is a side perspective view of the cup blender of FIG. 28, in accordance with various disclosed aspects herein:

FIG. 30 is a front cross-sectional view of the cup blender of FIG. 28, in accordance with various disclosed aspects herein;

FIGS. 31A-B are perspective and enlarged views of an embodiment of the cup blender with a resilient clip on the base, in accordance with various disclosed aspects herein:

FIGS. 32A-B are front cross-sectional and enlarged views of an embodiment of the cup blender with a resilient clip on the base, in accordance with various disclosed aspects herein;

FIGS. 33A-B are perspective and enlarged views of an embodiment of the cup blender with a resilient clip on the base, in accordance with various disclosed aspects herein:

FIG. 34 is front cross-sectional view of an embodiment of the cup blender with a resilient clip on the base, in accordance with various disclosed aspects herein:

FIGS. 35A-B are perspective and enlarged views of an embodiment of the cup blender with a resilient clip on the base, in accordance with various disclosed aspects herein:

FIG. 36 is front cross-sectional view of an embodiment of the cup blender with a resilient clip on the base, in accordance with various disclosed aspects herein:

FIGS. 37A-B are perspective and enlarged views of an embodiment of the cup blender with a resilient clip on the base, in accordance with various disclosed aspects herein; and

FIG. 38 is front cross-sectional view of an embodiment of the cup blender with a resilient clip on the base, in accordance with various disclosed aspects herein.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made in detail to embodiments of the present teachings, examples of which are illustrated in the accompanying drawings. It is to be understood that other embodiments may be utilized, and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B: A employs C: or A employs both B and C). As another matter, the articles “a” and “an” are generally intended to mean “one or more” unless context suggest otherwise.

It is noted that references to a blender, blender system, and the like, are understood to include other mixing systems. It is further noted that while various embodiments refer to a personal blender or cup blender, various other systems and mixing appliances may be utilized in view of embodiments described herein. For example, embodiments may be utilized in mixing systems, various other food preparation systems, home appliances, or other kitchen appliances using motors, such as frothers, mixers, and electric whisks. As such, references to a personal or cup blender, blending system, and the like, are understood to include the various other machines.

Furthermore, while blending of “ingredients,” “contents,” or “foodstuffs” is described by various embodiments, it is noted that non-food stuff may be mixed or blended, such as paints, epoxies, construction material (e.g., mortar, cement, etc.), and the like. Moreover, blending of ingredients may result in a blended product. Such blended products may include drinks, frozen drinks, smoothies, shakes, soups, purees, salsas, sauces, sorbets, butters or milks (e.g. nut or oat), dips or the like. Accordingly, such terms may be used interchangeably unless context suggests otherwise or warrants a particular distinction among such terms. Further, such terms are not intended to limit possible blended products and should be viewed as examples of possible blended products.

As used herein, the phrases “blending process,” “blending program,” and the like are used interchangeably unless context suggest otherwise or warrants a particular distinction among such terms. A blending process may comprise a series or sequence of blender settings and operations to be carried out by the blending device. In an aspect, a blending process may comprise at least one motor speed and at least one time interval for the given motor speed. For example, a blending process may comprise a series of blender motor speeds to operate the blender blade at the given speed, a series of time intervals corresponding to the given motor speeds, and other blender parameters and timing settings. The blending process may further include a ramp up speed that defines the amount of time the motor takes to reach its predetermined motor speed. The blending process may be stored on a memory and recalled by or communicated to the blending device.

Embodiments disclosed herein relate to cup blender systems and methods utilizing a cup blender system. Disclosed cup blender systems generally include a housing, a motor, a power source such as a battery, and a blade assembly. The housing may contains the motor and power source. The motor may drive the blade assembly via a drive shaft. Such cup blender systems may be operatively utilized to mix or blend contents within a cup or other vessel from which a user may also consume a blended product. As such, described cup blenders are typically hand held devices that may also be portable, and the sizes and arrangements of components may be more constrained compared to large format blending systems.

It is noted that large format blending systems may include household blenders, commercial blenders, food processors, or the like. Such systems typically include a blender base that receives a dedicated blender container, wherein the blender container includes or is coupled with a blade assembly. Such large format blending systems are not subject to similar constraints as cup blenders. Further, containers for such large format blending systems are generally specific to or designed for use with blender bases. These containers may come in different sizes (e.g., single serving, pitchers, etc.) but are typically designed to assist in the fluid dynamics of large format blending systems. Accordingly, teachings from such large format blending systems are generally not directly applicable to cup blenders.

Provided is a cup blending system having a motor housing. The motor housing may include a sipping mechanism. The sipping mechanism may allow for drinking of blended foodstuff immediately or near immediately after blending without having to remove or disengage components, such as a lid from a blending container or a blending container from a motor base. The sipping mechanism provided through the motor housing may allow for minimal components of the cup blending system and may not require an additional cover or lid at the open end of the container, which is typically required in traditional blending systems (e.g., using a motor base and a lid). The cup blending system may include a motor base with an asymmetric orientation of mixing and/or electrical components.

Provided is a cup blending system comprising a cup and a motor base. The motor base may include a sipping mechanism that includes a sipping pathway and a plug that operatively opens and closes access to the sipping mechanism. In a closed position, the plug may seal the sipping pathway at or near the internal wall and at or near the external wall. In an open position, the plug may be inserted into a plug receptacle adjacent the sipping pathway. The plug receptacle and sipping pathway may be sealed from contents of the cup in a closed position. The electrical components of the motor base, such as one or more of the motor, battery, drive shaft, and blade assembly, may be offset from a central axis of the motor base to accommodate the sipping mechanism. The blending system may be portable.

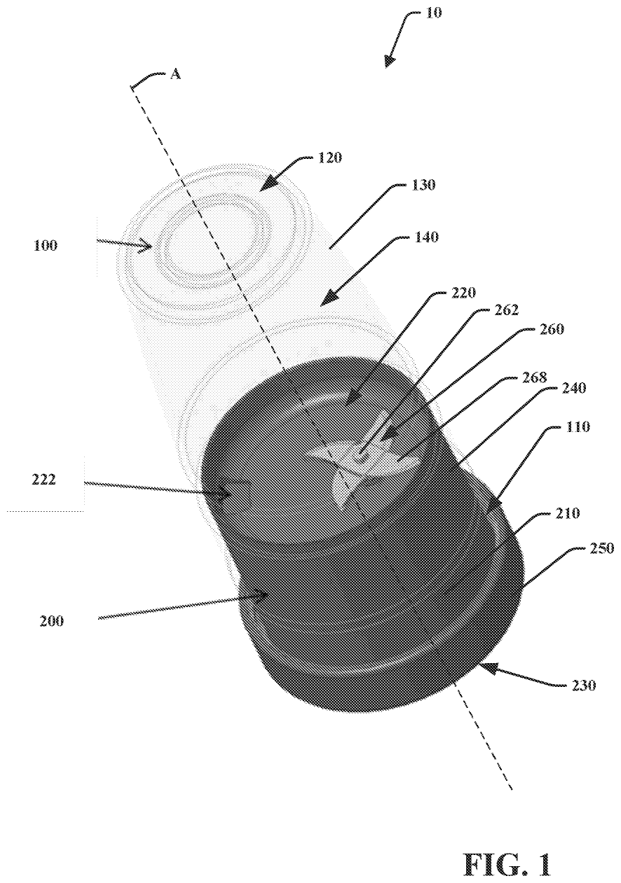

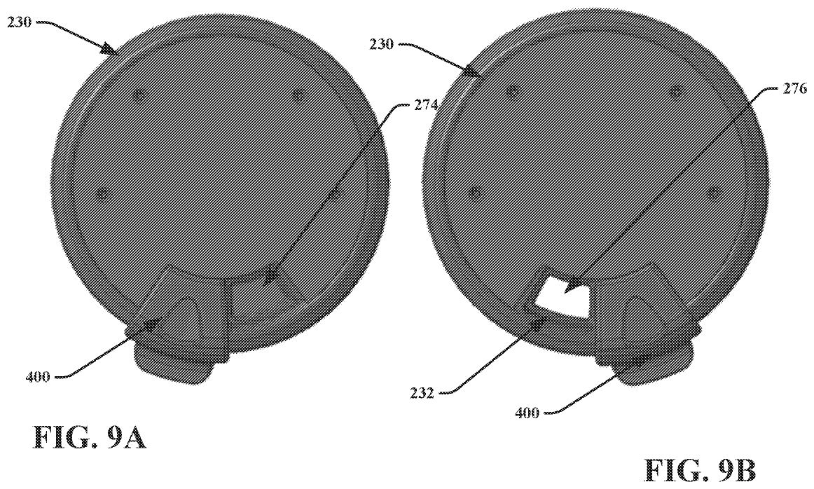

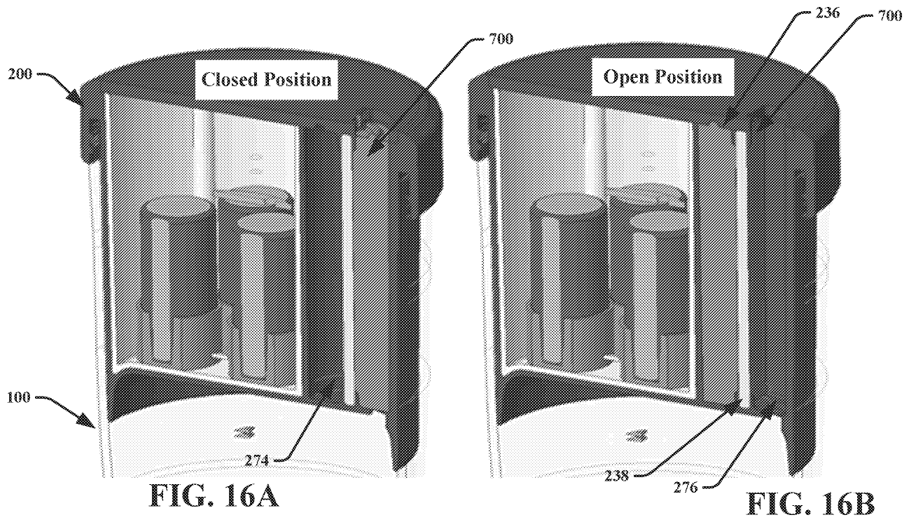

Turning to FIGS. 1-4B, (and as applicable to FIGS. 1-38) shown is a blending system 10, including a blending cup 100 selectively attached to a motor base 200. The motor base 200 may include a housing 210 having an interior end 220, an exterior end 230, and at least one sidewall 240 between the interior end 220 and exterior end 230. The housing 210 may include a cavity 245. The exterior end 230 may include a user interface communicatively coupled to or including a driver circuit 269. The housing 210 may further include a lip or apron 250 that extends from the sidewall 240 to form a ledge or stop for the cup 100. The cup 100 may include an open end 110, a closed end 120, at least one sidewall 130, and a cavity 140. It is noted that the housing 210 and cup 100 may comprise various shapes, sizes, and materials. In an example, the housing 210 and the cup 100 may include plastics, metal, glass, natural materials, or other food grade material as described herein.

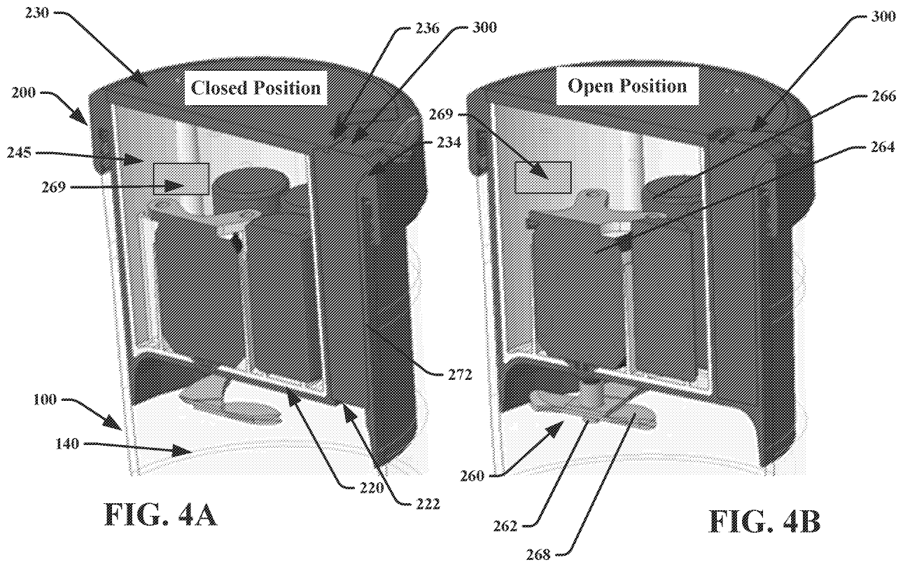

The blending system 10 may further include a blade assembly 260. The blade assembly 260 may extend from a surface of the interior end 220 of the motor base 200. The blade assembly 260 may include a drive shaft 262 which may be driven by motor 264, the motor 264 may be powered by a power source 266, such as a battery. The blade assembly 260 may include one or more blades 268 extending from the drive shaft 262. While blades 268 are described, other mixing devices may be utilized, such as frothers, whisks, or the like. It is noted that the blade assembly 260 may be offset or otherwise not axial to a central axis A of the motor base 200 or blending system 10 as shown in FIG. 1. One or more (or all) of the motor 264, power source 266, blade assembly 260, and drive shaft 262 may be offset or otherwise not axial to the central axis A of the motor base 200 or blending system 10 as shown in FIGS. 4A-B for example. In at least some embodiments, the blade assembly 260 and other components may also align or be coaxial with the central axis A of the blending system 10.

The motor base 200 may further include a channel or pathway 270 that extends from the interior end 220 of the motor base 200 to the exterior end 230 of the motor base 200. The channel or pathway 270 may also be referred to as a sipping mechanism. The channel 270 may allow access to the cavity 140 of the cup 100 through the motor base 200 while sealing cavity 245 from an external environment to prevent flow of foodstuff within the cavity 245. The channel 270 may provide access to the cavity 140 of the cup 100 from the interior end 220 of the motor base 200 and to the exterior end 230 of the motor base 200. The channel 270 may include a first opening 222 at the interior end 220 and a second opening 232 at the exterior end 230.

The channel 270 may be circumscribed or defined by walls 272 of the housing 210, the walls 272 (FIG. 4A) which may separate the channel 270 from the cavity 245 of the motor base 200. The walls 272 may enclose the channel 270 in the motor base 200 on all sides except the first opening 222 and the second opening 232. For instance, the sidewalls 240 of the motor base 200 may be separate from the walls 272 of the channel 270. In some embodiments, the sidewalls 240 of the motor base 200 may form one of or part of the walls 272 of the channel 270. For instance, the channel 270 may be formed at or near a periphery of the housing 210. In an example, the channel 270 may comprise a horseshow or jig-saw shape, where the plug, e.g., the mechanism that closes the channel 270 in a closed position, has a corresponding shape. A portion of the plug which contacts the sidewalls 240 may comprise or form a seal. The walls 272 may include one or more walls, and may be cylindrical, prismatic, or irregular in shape.

The channel 270 may generally have the same diameter or radius throughout the length of the channel 270, or the channel 270 may flare or taper as desired. The channel 270 may be sized and shaped to fit the plugs, e.g. plugs 300, 400, 500, 600, 700, described herein in both open and closed positions. The plugs may be removable, repositionable, or disposable. In examples, plugs may be removed for cleanability.

In embodiments, the channel 270 may include a portion or receptacle 274 that houses a plug in an open position and a portion as described that enables access 276 (e.g., sipping) through the motor base 200 to the cavity 140 of the cup 100 in an open position. In a closed position, the plug may transition from the plug receptacle 274 and into the access portion 276 to seal the channel 270 from contents from the cup 100. The plug receptacle 274 may be also be sealed from contents from the cup 100 when the plug is in a closed position. The plug receptacle 274 may be sealed from or inaccessible to contents from the cup 100 when the plug is in any of a closed position or an open position (e.g., the plug receptacle may remain clean or prevented from having foodstuff enter thereto). In some embodiments including an elongated plug that is moveable into a portion of the motor base 200 in an open position, the plug receptacle 274 and the sipping pathway 276 may be adjacent to one another and form the channel 270. In other embodiments not including this type of plug, the sipping pathway 276 alone may form the channel 270.

It is noted that general aspects, references and descriptions of the cup 100 and motor base 200 herein may be applied to any of the embodiments shown in FIGS. 1-38, or any figures or drawings included in this application, unless context suggests or this description states otherwise. Between embodiments, the shape and length of the channel 270 and mating components (e.g. rails) of the motor base 200 may be varied to accommodate the different embodiments of plugs as described herein.

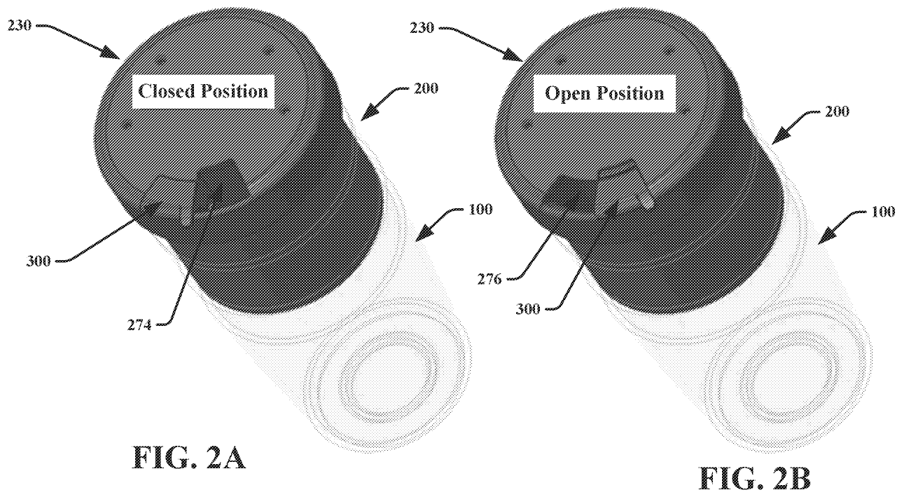

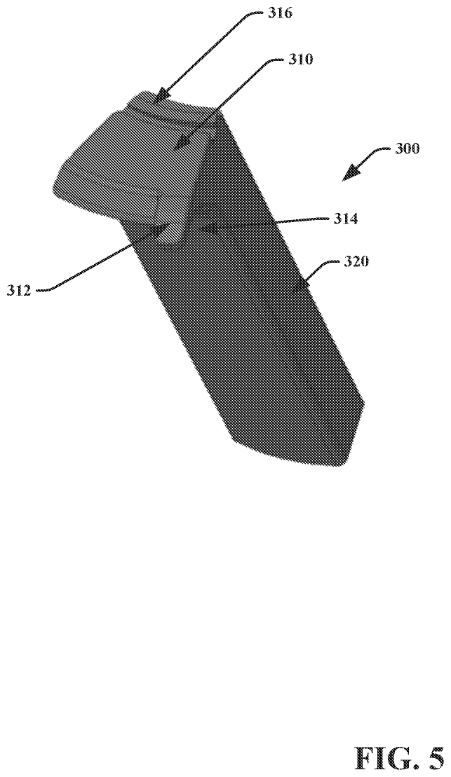

Turning to FIG. 5, shown is a first plug 300. First plug 300 is also shown in FIGS. 2A-4B as a component of blending system 10. The first plug 300 may include a top surface 310 and an arm 320 extending from the top surface 310. The plug 300 may be generally sized and shaped to plug the channel 270 and to selectively seal the first opening 222 and the second opening 232 of the channel 270. In an embodiment, the arm 320 may traverse nearly the entirety or the entirety of the channel 270. The plug 300 may also include a protrusion 312 that extends from at least a portion of the top surface 310 and that may be used by a user to selectively move or transition the plug 300 between open and closed positions. The protrusion 312 may extend in any direction and be of any desirable size. In an embodiment and as shown in FIG. 5, the protrusion 312 may extend laterally from the top surface 310 and may extend slightly from the sidewalls 210 of the motor base 200 when the plug 300 is inserted into the channel 270.

The plug 300 may include mating components or engagement features 314, 316 such as tracks, which may interact and engage with corresponding mating components or engagement features 234, 236 of the motor base 200, such as rails. The tracks and rails may guide the plug between open and closed positions. The plug 300 may include a first engagement feature 314 on an underside of the top surface 310 and a second engagement feature 316 on a top of the top surface 310. In an embodiment, the second engagement feature 316 may insert under a portion of the exterior surface 230 so that the plug 300 cannot be removed from the channel 270 when in a closed position. In an embodiment, the second engagement feature 316 may be revealed and seen from the portion of the exterior surface 230 so that the plug 300 can be removed from the channel 270 when in an open position. In at least some embodiments, the motor base 200 and the plug 300 may include an interlock mechanism that may prevent or reduce accidental removal of the plug 300 when in the closed position. For instance, the motor base 200 and/or the plug 300 may include a mechanical interlock mechanism (e.g., tab, pin, sliding-lock, thumbscrew, friction fit, bayonet lock, etc.), a magnetic interlock, or the like. The interlock mechanism may be engaged to selectively allow removal of the plug 300, prevent or reduce accidental removal, or otherwise allow a user to determine when to remove the plug 300.

The plug 300 may be configured to keep foodstuff within the cavity 140 of the cup 100 when in a closed position as shown in FIGS. 2A, 3A, and 4A. The plug 300 may be able to rotate within channel 270 to an open position as shown in FIGS. 2B, 3B, and 4B to selectively open the channel 270 between the first opening 222 and the second opening 232 and to allow access into the cavity 140 of the cup 100, for example, in order to access or drink the blended foodstuff therein. The plug 300 and the rotation thereof from a closed position to an open position, and vice versa, allows foodstuff to be blended by the blending system 10 in a closed position and then to be consumed by the user in an open position without having to remove the motor base 200.

In an embodiment, the plug 300 may be rotatable between 10 and 50 degrees. In an embodiment, the plug 300 may be rotatable for 30 degrees between the open and closed positions.

The plug 300 may comprise food safe material, such as a food grade plastic or metal. The plug 300 may include one or more gaskets that may be compressed when in an open or closed position to seal the pathway 270 or other components.

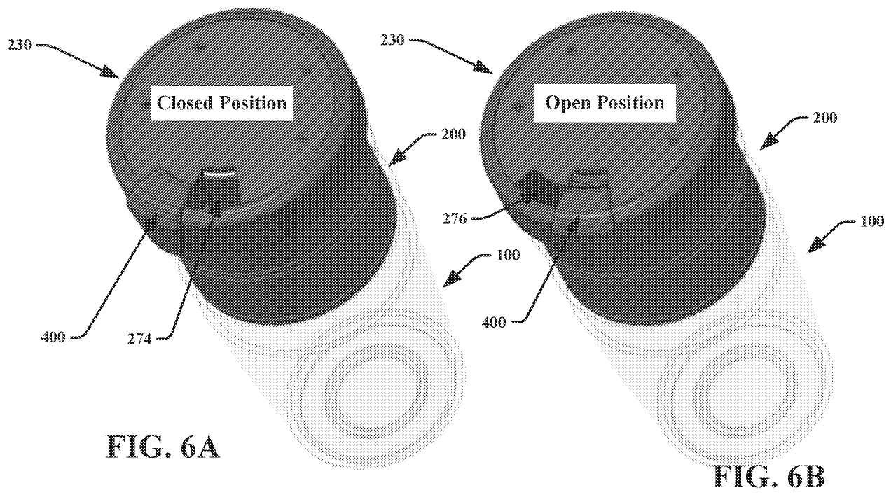

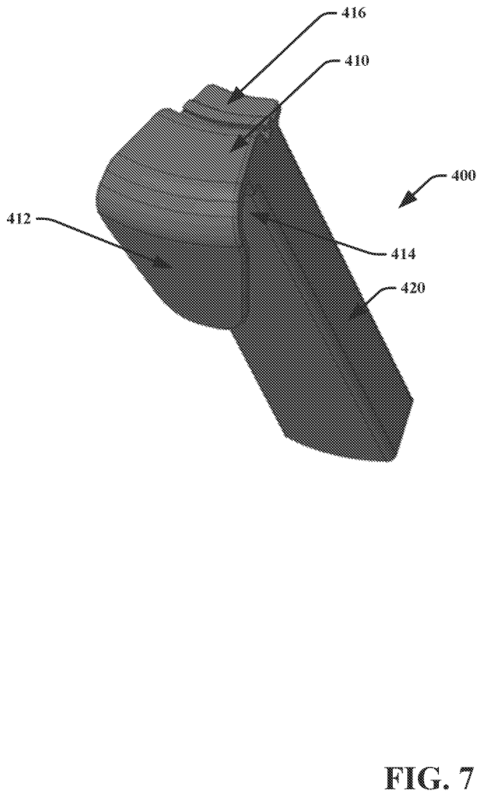

Turning to FIGS. 6-7, shown is a second plug 400. Second plug 400 may be similar to first plug 300 in having a top surface 410 and an arm 420 extending from the top surface 310. Second plug 400 may be similar to first plug 300 in the transition between an open and closed positions. Second plug 400 may be similar to first plug 300 in the selective accessibility of cavity 140 and foodstuff therein. Second plug 400 may be similar to first plug 300 in the engagement features with the motor housing 200. As such, any of the described elements of first plug 300 may be applied to second plug 400 in any combination and vice versa.

Second plug 400 may differ from first plug 300 in having a larger protrusion 412. For example, where protrusion 312 may have extended partially and laterally from the top surface 310 of the first plug 300 and minimally over an edge of the sidewall 210 or apron 250 of the motor housing 200, protrusion 412 may be a lip that extends from an entirety of the top surface 410 and may wrap around or overhang the sidewall 210 or apron 250 of the motor housing 200 as shown in FIGS. 6A-B. This larger surface protrusion 412 and overhang may allow for easier sliding capability between open and closed positions. It is noted that one or more of these described different features for second plug 400 may also be included and adapted to first plug 300 in any combination and vice versa.

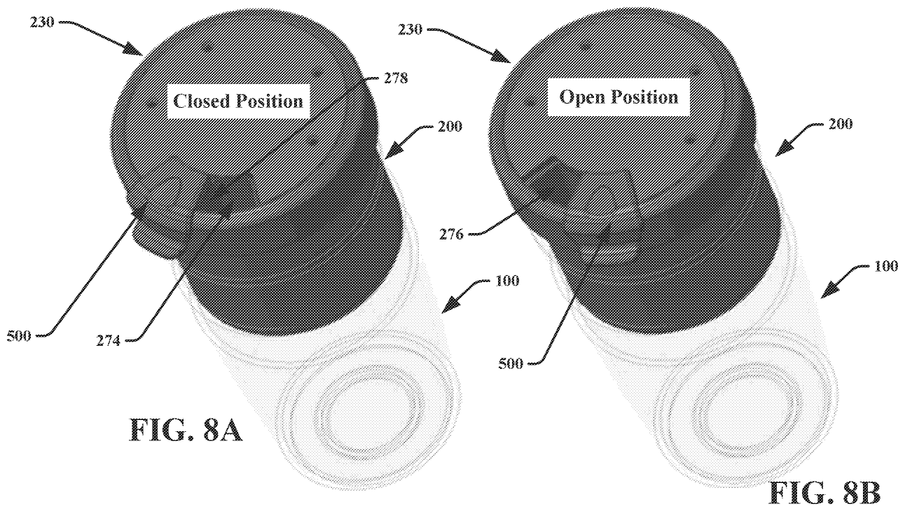

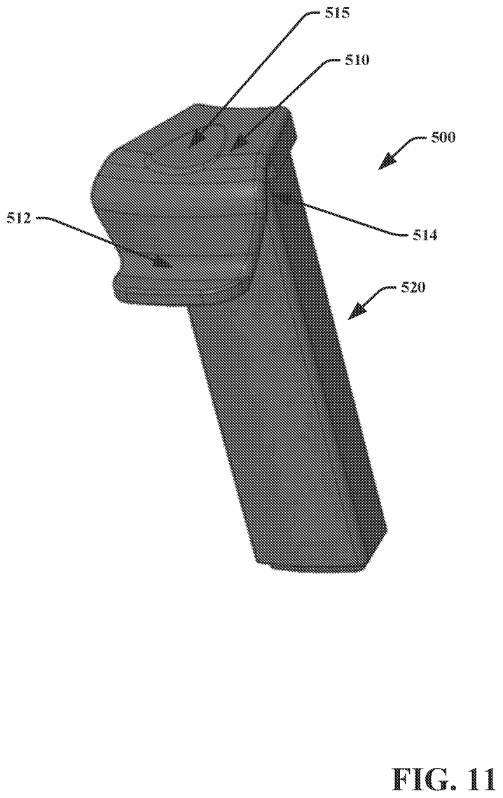

Turning to FIG. 11, shown is a third plug 500. Third plug is also shown in FIGS. 8-10 as a component of blending system 10. Third plug 500 may be similar to first plug 300 in having a top surface 510 and an arm 520 extending from the top surface 510. Third plug 500 may be similar to first plug 300 in the selective accessibility of cavity 140 and foodstuff therein. Third plug 500 may be similar to first plug 300 in the engagement features with the motor housing 200. As such, any of the described elements of first plug 300 may be applied to third plug 500 in any combination and vice versa.

Third plug 500 may differ from first plug 300 in the transition between an open and closed positions. For example, third plug 500 may not slide axially to transition between the open and closed positions. Instead, third plug 500 may be completely removed from the motor housing 200 (e.g., slid in a vertical direction or a direction in line with channel 270) and then placed in either the plug receptacle 274 for the open position or the sipping pathway 276 for the closed position (e.g., by sliding the fourth plug 600 in a vertical direction or a direction in line with channel 270, or the plug receptacle 274 or the sipping pathway 276 thereof). In an embodiment, the plug receptacle 274 and the sipping pathway 276 may be separated by wall 278. The third plug 500 may be held in place in each the plug receptacle 274 and the sipping pathway 276 by friction fit, magnets, locking tabs, snap fit connections, and the like.

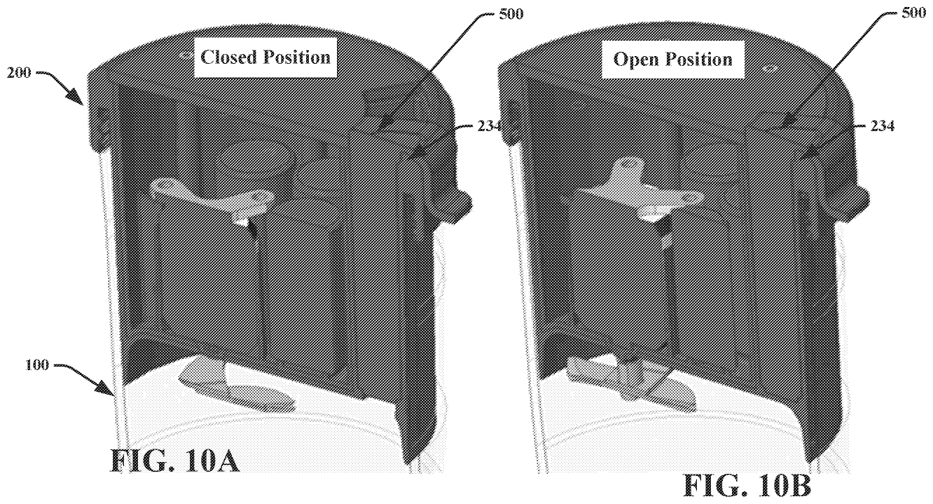

Third plug 500 may differ from first plug 300 in having a larger protrusion 512. Like protrusion 412, for example, where protrusion 312 may have extended partially and laterally from the top surface 310 of the first plug 300 and minimally over an edge of the sidewall 210 or apron 250 of the motor housing 200, protrusion 512 may be a lip that extends from an entirety of the top surface 510 and may wrap around or overhang the sidewall 210 or apron 250 of the motor housing 200 as shown in FIGS. 10A-B. This larger surface protrusion 512 and overhang may allow for easier sliding capability between open and closed positions.

Unlike lip 412 which wraps around or overhangs the sidewall 210 or apron 250 of the motor housing 200 in a substantially straight fashion (i.e., substantially perpendicular to top surface 410), lip 512 may start in a substantially straight fashion, but then may flare away from the sidewall 210 or apron 250 of the motor housing 200. Also, unlike first plug 300 and second plug 400, the third plug 500 may include second engagement feature 516 on a top of the top surface 510 that remains under or hidden by a portion of the exterior surface 230 in both open and closed positions. Further, as shown in FIGS. 8A-8B, third plug 500 may include a surface feature 515 on the top surface 510 of the plug 500, such as a slight recess or impression. The recess or impression may be any shape and size, including circular, rectangular, irregular, and the like, and may extend all or a portion of the top surface 510. The surface feature 515 may also include any type patterning or texture which, in an example, may allow for easier grip and movement of the third plug between open and closed positions by a user. It is noted that one or more of these described different features for third plug 500 may also be included and adapted to first plug 300 and second plug 400 in any combination and vice versa.

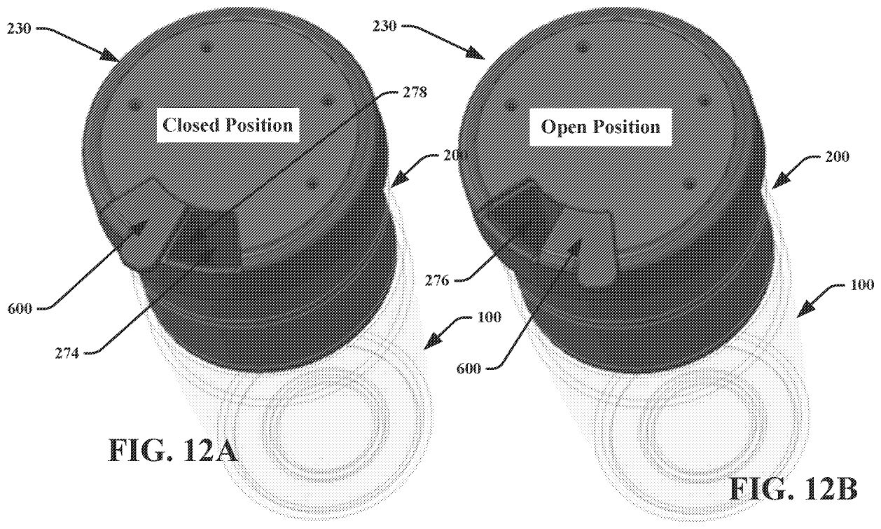

Turning to FIGS. 12A-13, shown is a fourth plug 600. Fourth plug 600 may be similar to first plug 300 in having a top surface 610 and an arm 620 extending from the top surface 610. Fourth plug 600 may be similar to first plug 300 in the selective accessibility of cavity 140 and foodstuff therein. Fourth plug 600 may be similar to first plug 300 in the engagement features with the motor housing 200. As such, any of the described elements of first plug 300 may be applied to second plug 600 in any combination and vice versa.

Fourth plug 600 may differ from first plug 300 in the transition between an open and closed positions. For example, fourth plug 600 may not slide axially to transition between the open and closed positions. Instead, fourth plug 600 may be completely removed from the motor housing 200 (e.g., slid in a vertical direction or a direction in line with channel 270) and then placed in either the plug receptacle 274 for the open position or the sipping pathway 276 for the closed position (e.g., by sliding the fourth plug 600 in a vertical direction or a direction in line with channel 270, or the plug receptacle 274 or the sipping pathway 276 thereof). In an embodiment, the plug receptacle 274 and the sipping pathway 276 may be separated by wall 278. The fourth plug 600 may be held in place in each the plug receptacle 274 and the sipping pathway 276 by friction fit, magnets, locking tabs, snap fit connections, and the like.

Fourth plug 600 may differ from first plug 300 in having a longer protrusion 612. For example, where protrusion 312 may have extended partially and laterally from the top surface 310 of the first plug 300 and minimally over an edge of the sidewall 210 or apron 250 of the motor housing 200, protrusion 412 may similarly extend partially and laterally from the top surface 610 of the first plug 300 but extend further over an edge of the sidewall 210 or apron 250 of the motor housing 200 as shown in FIGS. 12A-B. This larger surface protrusion 612 and overhang may allow for easier sliding capability between open and closed positions. It is noted that one or more of these described different features for fourth plug 600 may also be included and adapted to first plug 300, second plug 400, or third plug 500 in any combination and vice versa.

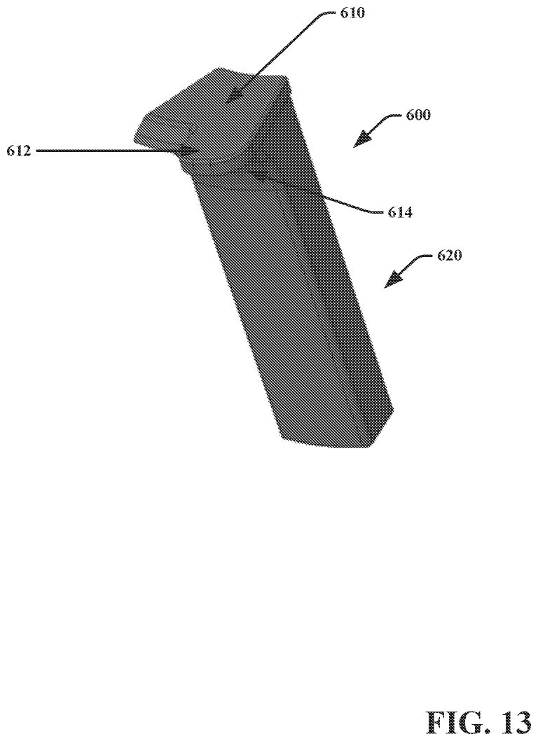

Turning to FIG. 17, shown is a fifth plug 700. Fifth plug 700 is also shown in FIGS. 14-16 as a component of blending system 10. The fifth plug 700 may include a top surface 710 and an arm 720 extending from the top surface 710. The plug fifth 700 may be generally sized and shaped to plug the channel 270 and to selectively seal the first opening 222 and the second opening 232 of the channel 270. In an embodiment, the arm 720 may traverse nearly the entirety or the entirety of the channel 270. The fifth plug 700 may also include a protrusion 712 that extends from at least a portion of the top surface 310 and that may be used by a user to selectively move or transition the fifth plug 700 between open and closed positions. The protrusion 712 may extend in any direction and be of any desirable size. In an embodiment and as shown in FIG. 17, the protrusion 712 may extend perpendicularly and upwards away from the top surface 710.

While plugs 300, 400, 500, 600 had a similar body, top surface, or arm shape, as in being generally a quadrilateral shape or partial wedge shape, fifth plug 700 may be generally circular. Similarly channel 270 in this embodiment may be sized and shaped corresponding to fifth plug 700 and may also be generally circular, whereas in prior embodiments, channel 270 was sized and shaped to plugs 300, 400, 500, 600 and had a generally quadrilateral shape or partial wedge shape.

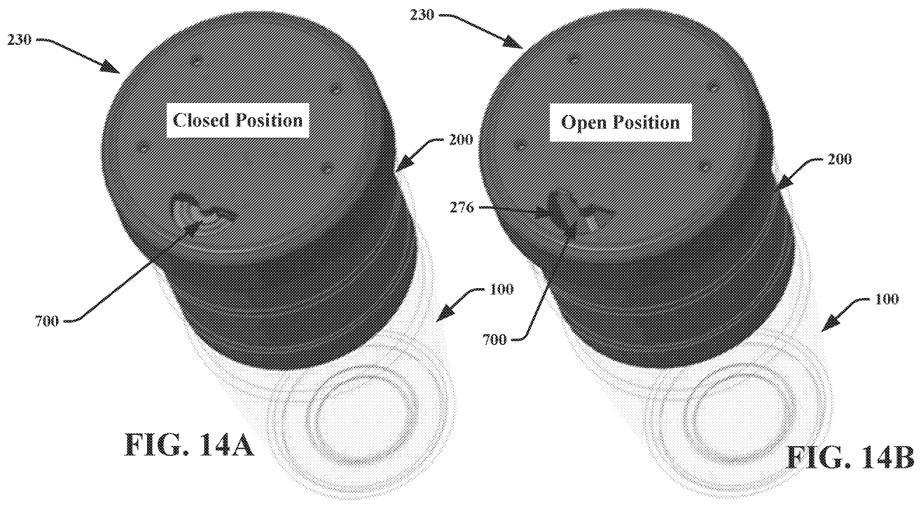

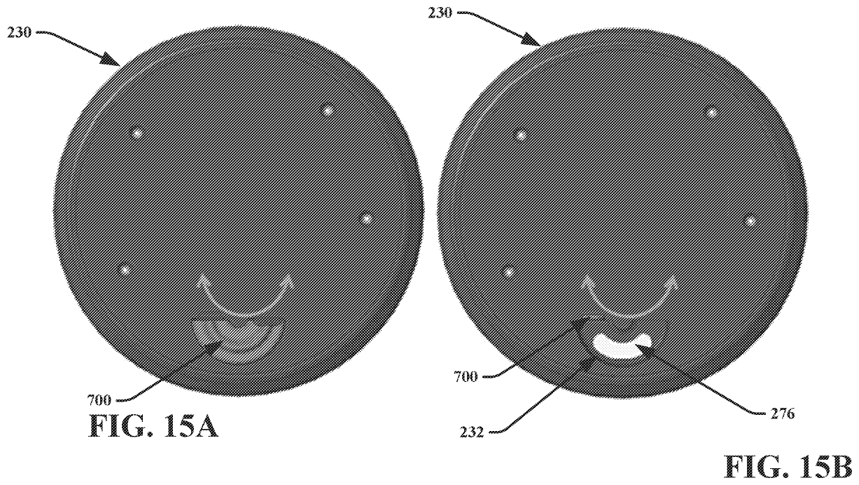

The fifth plug 700 may include mating components or engagement features 716 such as tracks, which may interact and engage with corresponding mating components or engagement features 236 of the motor base 200, such as rails. The tracks and rails may guide the plug between open and closed positions. The fifth plug 700 may include a first mating feature 716 on a top of the top surface 710. In an embodiment, the first mating feature 716 may insert under a portion of the exterior surface 230 so that the first mating feature 716 is substantially hidden when in a closed position. In the closed position, the top surface 710 of the plug 700 may also be insert under a portion of the exterior surface 230 so that the fifth plug 700 is substantially hidden when in a closed position. In an embodiment, all of the fifth plug 700 but protrusion 712 may be hidden as shown in FIGS. 15A-B.

The fifth plug 700 may include its own channel 718 extending though the entirety of the fifth plug 700, including the top surface 710 and arm 720, for example, located in a center axis of the fifth plug 700. A rod 238 may attach to or formed with the motor base 200 and extend through channel 718. Fifth plug 700 may rotate about this channel 718 and rod 238.

The fifth plug 700 may be configured to keep foodstuff within the cavity 140 of the cup 100 when in a closed position as shown in FIGS. 14A, 15A, and 16A. The fifth plug 700 may be able to rotate within channel 270 and around rod 238 to an open position as shown in FIGS. 14B, 15B, and 16B to selectively open the channel 270 between the first opening 222 and the second opening 232 and to allow access into the cavity 140 of the cup 100, for example, in order to access or drink the blended foodstuff therein. The fifth plug 700 and the rotation thereof from a closed position to an open position, and vice versa, allows foodstuff to be blended by the blending system 10 in a closed position and then to be consumed by the user in an open position without having to remove the motor base 200.

In an embodiment, the fifth plug 700 may be rotatable between 160 and 200 degrees. In an embodiment, the plug may be rotatable for 180 degrees between the open and closed positions.

It is noted that one or more of these described features for fifth plug 700 may also be included and adapted to first plug 300, second plug 400, third plug 500, or fourth plug 600 in any combination and vice versa. Similarly, any of the described features for any of first plug 300, second plug 400, third plug 500, or fourth plug 600 may also be included and adapted to fifth plug 700 in any combination and vice versa.

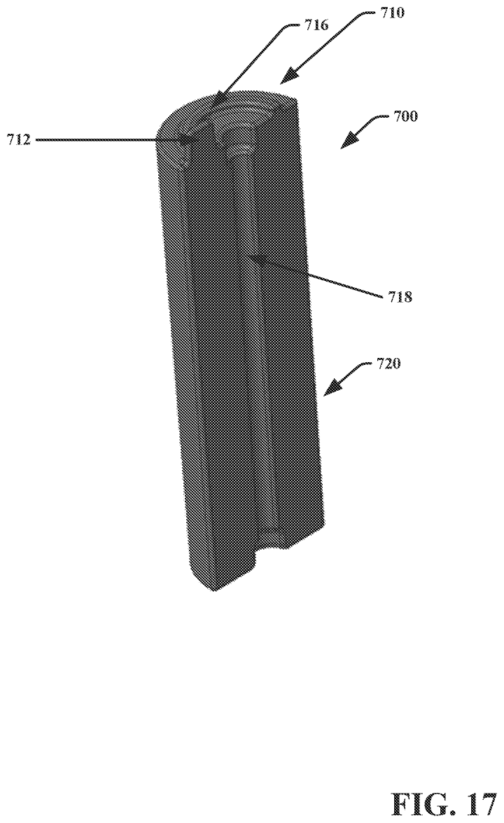

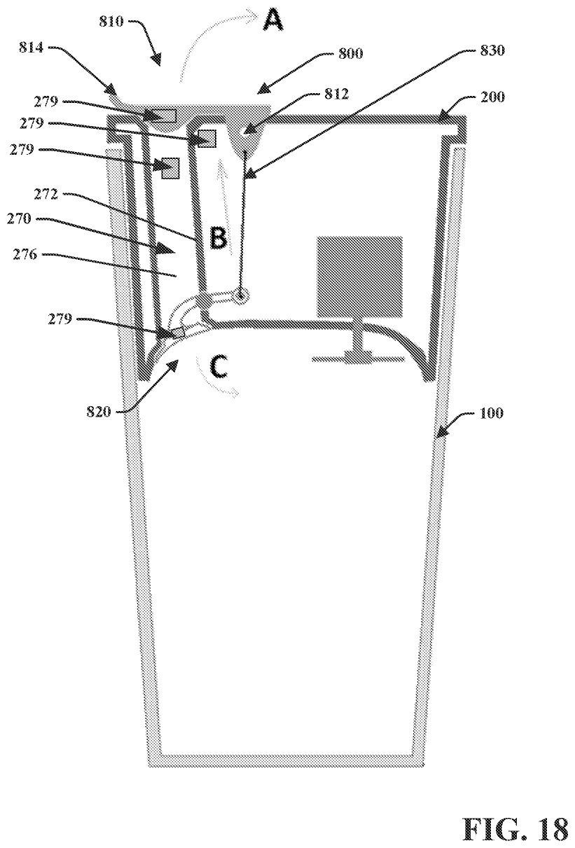

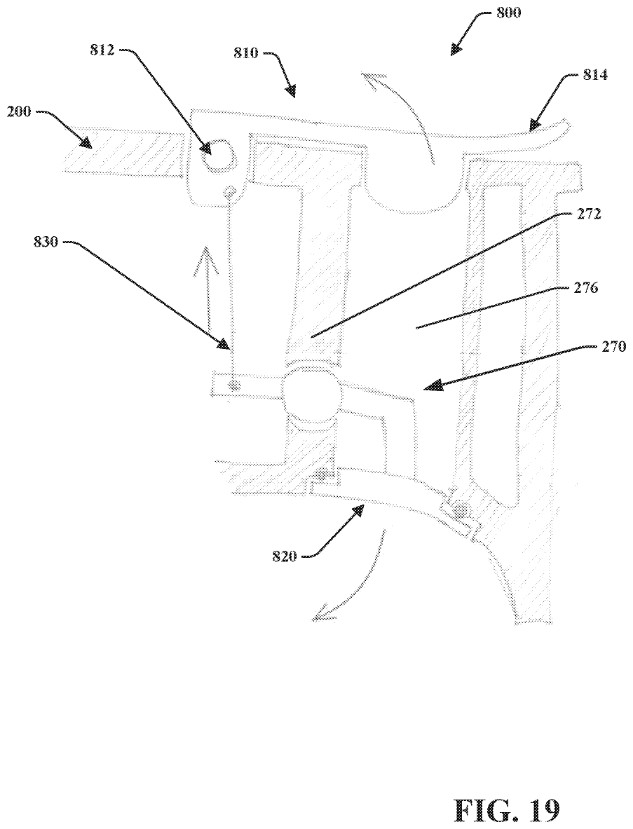

Turning to FIGS. 18-19, shown is sixth plug 800. Sixth plug 800 includes a first lid 810 and a trap door 820. In an embodiment, the first lid 810 may be a hinged top closure. In an embodiment, the trap door 820 may be a hinged bottom closure. It is noted that the top closure and the bottom closure may include engagement or closure mechanisms other than being hinged, such as snap fit, friction fit, etc. In an embodiment, the hinged top closure and hinged bottom closure are linked so that transitioning the hinged top closure to the open position causes the hinged bottom closure to open, and transitioning the hinged top closure to the closed position causes the hinged bottom closure to close.

The first lid 810 may selectively cover and seal the second opening 232 at the exterior surface 230. The trap door 820 may selectively cover and seal the first opening 222 at the interior surface 220. The channel 270 may otherwise remain unoccupied by sixth plug 800 except at these second 232 and first openings 234. The first lid 810 may be on a hinge 812 and may include lip 814 for ease of opening. Once opened about the hinge 812, first lid 810 may open and a linkage 830 between the first lid 810 and a trap door 820 may be released, thereby also opening the trap door 820. When closed about the hinge 812, first lid 810 may close and a linkage 830 between the first lid 810 and a trap door 820 may be pulled, thereby also closing the trap door 820. The linkage 830 may be housed within the cavity 245 of the motor base 200. The first lid 810 may be attached to the linkage 830 through the exterior surface 230 of the motor base 200. The trap door 820 may be attached to the linkage 830 through the wall 272 of the channel 270 of the motor base 200. The trap door 820 may be attached to the linkage 830 through the interior surface 220 of the motor base 200.

A user may open the first lid 810 in the direction of Arrow ‘A.’ Linkage 830 moves to the left, unlocking the trap door 820 and then moves along the arrow ‘B’ and pulls up the right side of the trap door 820. Trap door 820 moves along the direction of arrow ‘C’ and opens the channel 270 or the passage to sip or insert straw. The trap door 820 pivots along the solid red cylinder/sphere that is press fitted into an opening in the side wall of the channel 270 or sipping tube. The channel 270 may be rinsed easily by passing water through it when the first lid 810 is raised, or a small brush may be used to clean the channel and 270 opening 232.

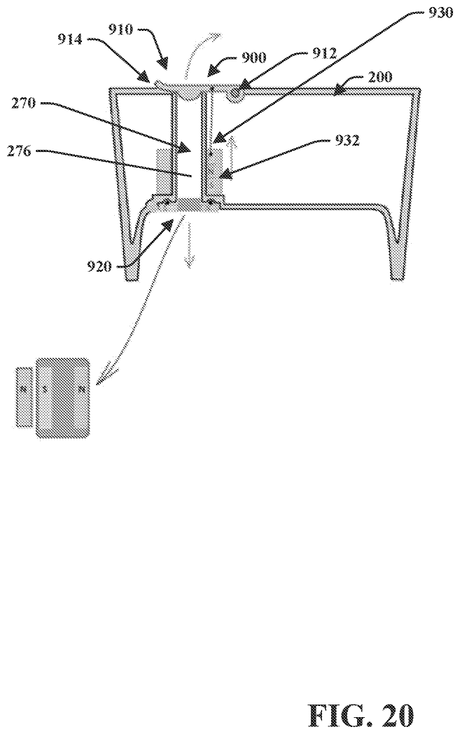

Turning to FIG. 20, shown is a seventh plug 900, which may generally include similar or the same aspects as sixth plug 800, but where the linkage 930 operates a magnetic latch 932. Seventh plug 900 may include a first lid 910 and a trap door 920. In an embodiment, the first lid 910 may be a hinged top closure. In an embodiment, the trap door 920 may be a hinged bottom closure. It is noted that the top closure and the bottom closure may include engagement or closure mechanisms other than being hinged, such as snap fit, friction fit, etc. In an embodiment, the hinged top closure and hinged bottom closure are linked so that transitioning the hinged top closure to the open position causes the hinged bottom closure to open, and transitioning the hinged top closure to the closed position causes the hinged bottom closure to close.

The first lid 910 may selectively cover and seal the second opening 232 at the exterior surface 230. The trap door 920 may selectively cover and seal the first opening 222 at the interior surface 220. The channel 270 may otherwise remain unoccupied by seventh plug 900 except at these second 232 and first openings 234. The first lid 910 may be on a hinge 912 and may include lip 914 for ease of opening. Once opened about the hinge 912, first lid 910 may open and a linkage 930 between the first lid 910 and a trap door 920 may be pulled and cause the magnetic connection to be interrupted, thereby also opening the trap door 920. When closed about the hinge 912, first lid 910 may close and a linkage 930 between the first lid 910 and a trap door 920 may be released and cause the magnetic connection to be restored, thereby also closing the trap door 920. The linkage 930 may be housed within the cavity 245 of the motor base 200. The first lid 910 may be attached to the linkage 930 through the exterior surface 230 of the motor base 200. The trap door 920 may interact with the linkage 930 through a magnet connection through the wall 272 of the channel 270 of the motor base 200 or through the interior surface 220 of the motor base 200. Linkage 930 may include a magnet within cavity 245 of the motor base 200 near or at an opposite magnet on the trap door 920.

In some embodiments, a user may open first lid 910. A plastic-cylinder may slide up a side (such as the outside or left side) of the channel 270. Trap door 920 may loosen a magnetic attraction on its other side (such as the inside or right side) and swing about a magnetic hinges on the left side, using gravity, allowing the opening of a channel 270. User may close the first lid 910. Plastic-cylinder may move down and reach bottom position. When the motor housing 200 is inverted, the trap door 920 falls due to gravity and rotates at the hinge on the left side, bringing the magnets within proximity and locking. Rubber O-rings may be provided to seal between the trap door 920 and the channel 270.

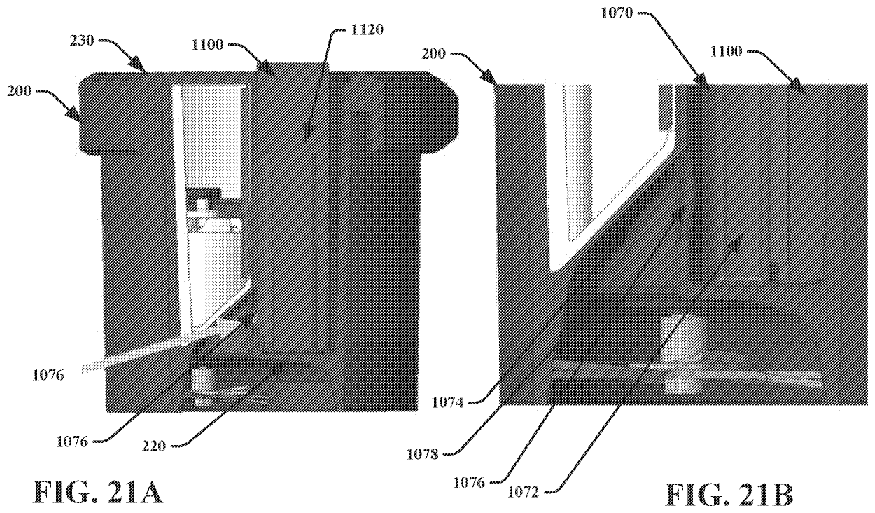

Turning to FIGS. 21-24, shown is a second blending system 1000. Second blending system 1000 may include similar or the same components as first blending system 10. For example, second blending system 1000 may include a blending cup 100 selectively attached to a motor base 200. It is noted that general aspects, references and descriptions of the blending cup 100 and motor base 200 as described in reference to FIG. 1 and others, may be applied to the embodiments of FIGS. 21-24 unless context suggests or this description states otherwise. For example, instead of channel 270 which can directly extend from the interior surface 220 of the motor base 200 to the exterior surface 230 of the motor base 200, channel 1070 of blending system 1000 may include a two-part channel that can minimize the area needed to be plugged between open and closed positions and that may increase the ease and success of sealing during processing or blending. In an embodiment, all other aspects of blending container 100 and motor base 200 as described in reference to FIG. 1 and others, aside from this channel 270/1070, may be the same between the first blending system 10 and the second blending system 1000. Moreover, the channel 1070 having two or more channels, branches, or the like, may be incorporated into any of FIGS. 1-20, into the first blending system 10, and into any of the embodiments including plugs 300, 400, 500, 600, 700, 800, 900.

Between embodiments, the shape and length of the channel 1070 and mating components (e.g. rails) of the motor base 200 may be varied to accommodate the different embodiments of plugs or channel shapes as described herein. The channel 1070 may be sized and shaped to fit the plugs, e.g. plugs 300, 400, 500, 600, 700, described herein in both open and closed positions. The plugs may be removable, such as in the open position, for cleanability. It is noted that any of the described plugs 300, 400, 500, 600, 700, 800, 900 and any, one or more, or all of the described different features for any of plugs 300, 400, 500, 600, 700, 800, 900 may also be included and adapted to this blending system 1000 and plug 1100 in any combination and vice versa. Plug 1100 having additional attachment or mating features, including magnets, or the like, may be incorporated into any of FIGS. 1-20, into the first blending system 10, and into any of the embodiments including plugs 300, 400, 500, 600, 700, 800, 900.

As shown in FIGS. 21-24, shown is blending system 1000 having plug 1100 and channel 1070. Channel 1070 may include a first length 1072 to accommodate plug 1100, and which may resemble channels 270 described herein except not extending entirely through the interior surface 220 of the motor base 200 (e.g. not including first opening 222), and may include a second length or branch 1074, that branches off from the first length 1072 of channel 1070 at seal opening 1076 and that fluidly connects the first length 1072 to the blending container 100, e.g., that does open or extend through the interior surface 220 of the motor base 200 at opening 1078. Channel 1070 including first length 1072 and branch 1074 may comprise the sipping channel. Channel 1070 may further comprise a plug receptacle separate first length 1072 and branch 1074 for housing the plug 1100 in open positions. For example, first length 1072 may extend from the exterior surface 230 of the motor base 200 at first opening 232 to a position at or near the interior surface 220 of the motor base 200, but, in an embodiment, first channel 1072 may not extend directly through the interior surface 220 of the motor base 200 and may not itself form an opening 222. Instead, second length or branch 1074 may begin or extend from any point or position on first length 1072 at seal opening 1076. This second length or branch 1074 may then form opening 1078 through the interior surface 220 of the motor base 200.

Plug 1100 may be generally sized and shaped to plug or fill the first length 1072 of channel 1070 and to selectively seal first length 1072 from second length or branch 1074 at the seal opening 1076 and may selectively seal the second opening 232 (the second opening 232 which may be similar or the same as described in reference to the other embodiments shown in FIGS. 1-20). In an embodiment, the arm 1120 of the plug 1100 may traverse nearly the entirety or the entirety of the first length 1072 of channel 1070. In an embodiment, neither plug 1100 nor any portion thereof, such as arm 1120, may enter into or occupy second length or branch 1074 except at the seal opening 1076.

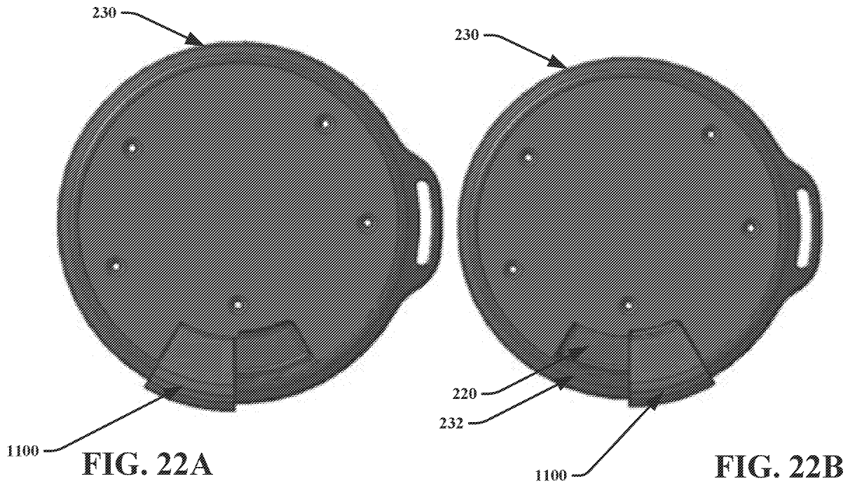

Plug 1100 may be able to rotate (e.g., along the other perimeter of the exterior surface 230) within the first length 1072 of channel 1070 to an open position as shown in FIGS. 21B and 22B to selectively open the channel 1070 between opening 232 on the exterior surface 230 of the motor base 200 to seal opening 1076 (and the seal opening 1076 to opening 1078 at the interior surface 200 of the motor base 200) and to allow access into the cavity 140 of the cup 100, for example, in order to access or drink the blended foodstuff therein. The plug 1100 and the rotation thereof from a closed position to an open position, and vice versa, allows foodstuff to be blended by the blending system 1000 in a closed position and then to be consumed by the user in an open position without having to remove the motor base 200.

In an embodiment, the plug 1100 may be rotatable between 10 and 50 degrees. In an embodiment, the plug 1100 may be rotatable for 30 degrees between the open and closed positions.

In an embodiment, seal opening 1076 may be circular. It is also noted that seal opening 1076 may be any desired shape, such as rectangular, square, ovular, irregular, etc. Similarly, the opening 1078 at the interior surface 220 may be any desired shape, such as circular, rectangular, square, ovular, irregular, etc. Opening 1078, in an embodiment, may be larger that seal opening 1076.

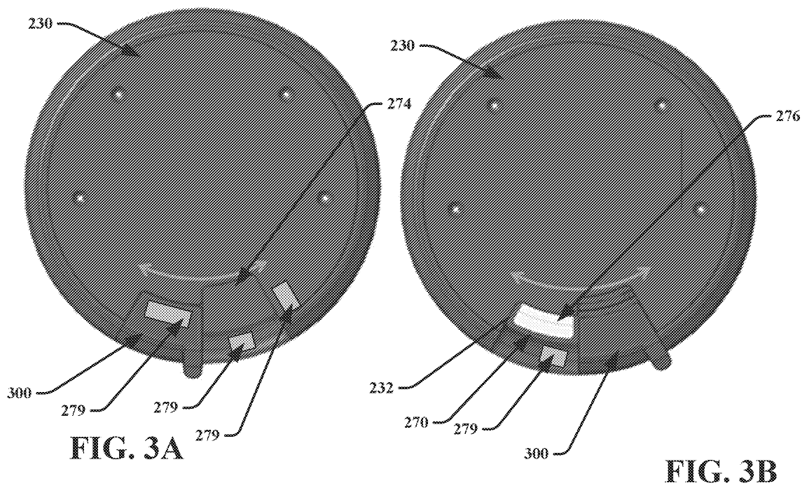

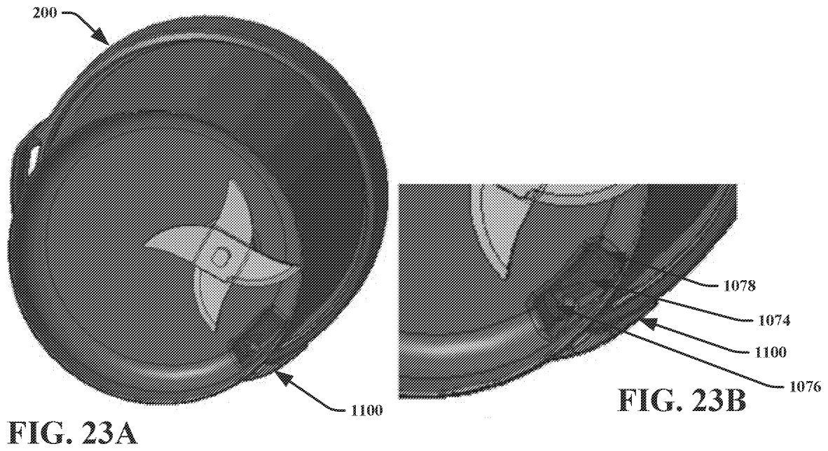

FIGS. 23A and 23B, for example, show the arm 1120 of plug 1100 covering seal opening 1076 in a closed or blending position so that foodstuff within the blending container 100 may be blended without entering into or through first length 1072 of the channel 1070 (because plug 1100 is blocking access to this part of the channel 1070) and through opening 232. As shown in FIG. 22B, in the open position, unlike other FIGs., such as FIG. 3B, for example, the opening 222 or entrance into the container 100 may not be seen from a top view and instead, the back of interior surface 220 may be seen. The entrance to the container 100 at opening 1087 may be angled out of view by the second length or branch 1074 of the channel 1070. In an embodiment channel 1070 may not be linear, and may instead be angled, curved, branched, or the like, based on the separate parts, branches, lengths, etc. of the channel 1070.

In an embodiment, channel 1070 and blending system 1000 may simplify the sealing process, may increase ease and success of sealing the blending chamber from the drinking hole, and may allow for a face seal to be used to prevent egress when processing a drink. As the plug 1100 rotates within and around channel 1070, it face seals on a vertical surface or opening, see FIGS. 21A-B. In an embodiment, a straw may be fitted through the branched channel 1070 when the plug 1100 is an open position. The straw may be positioned at an angle or the straw itself may be appropriate angled to traverse the channel 1070 in an open position and to facilitate the drinking of blended contents within the blending container 100, through the motor base 200 and channel 1070, to the user. The channel 1070 may also be used, and the blending system 1000 tilted, to facilitate direct drinking of blending contents through the channel 1070 in an open position to the user's mouth.

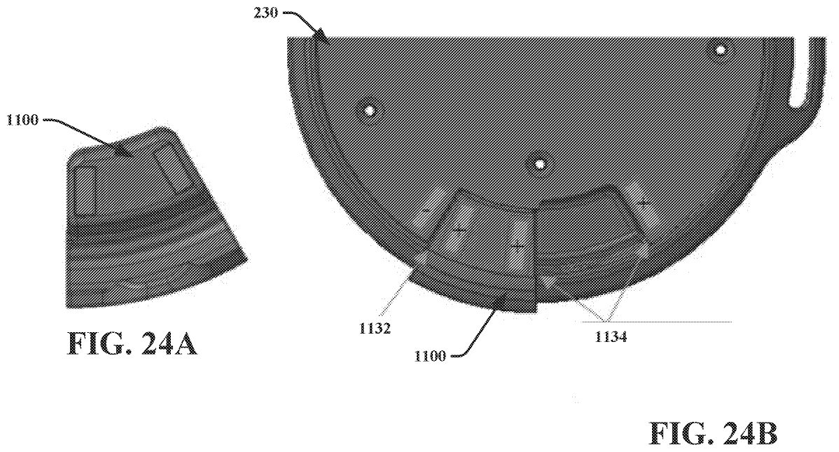

Turning to FIGS. 24A-B, shown are magnets as they relate to plug 1100 and opening 232. For example, plug 1100 may be controlled by attracting 1132 or repelling magnets 1134 in the plug 1100 and at or near opening 232. In an embodiment, the plug 1100 may be skewed or biased to a closed position at all times by attracting (+) (−) magnets 1132. For example, one or more magnets having a first charge, e.g. a positive charge as shown in FIG. 24, may be positioned in the plug 1100 and at the side of the opening 232 where the plug 1100 nears or meets in an open position (thus repelling magnets in the plug 1100). At least one negative or oppositely charged magnet may be positioned at the side of the opening 232 where the plug 1100 nears or meets in a closed position (thus attracting the magnets in the plug 1100). The user could overcome this attraction by providing force on the plug 1100 and sliding the plug 1100 from the closed position to the open position to drink the contents in the blending system or container. In an embodiment, this closure may prevent the cup 100 or blending system from spilling if accidently tipped over. Magnets could be over molded, insert molded, or manufactured many ways to be contained inside the plug 1100.

Although embodiments of the magnetic closure are described in reference to plug 1100, it is noted that any plugs 300, 400, 500, 600, 700 may similarly use or incorporate this magnetic enclosure, as well as plugs 800, 900. It is also noted that the magnetic closure may be applied to first blending system 10, second blending system 1000, and any other embodiments of blending systems, plugs, channels, or the like as disclosed and described herein.

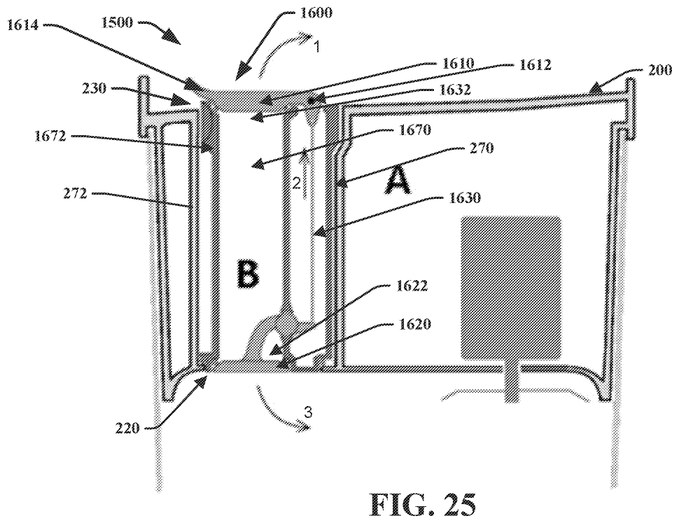

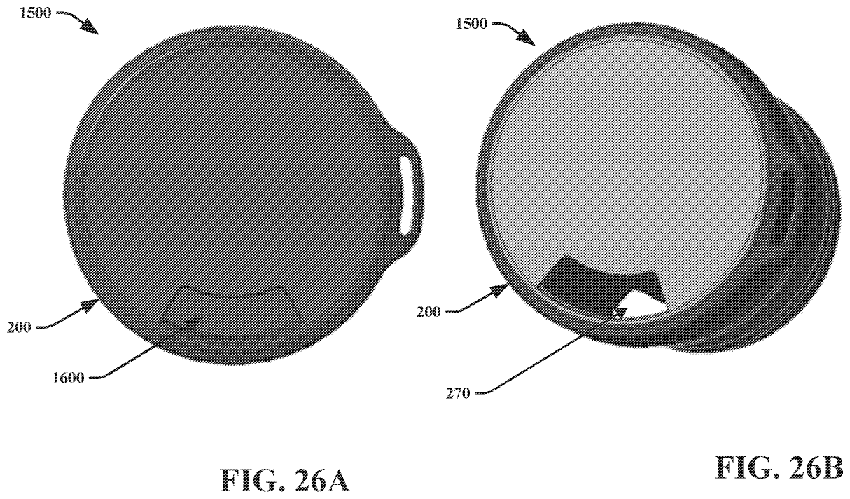

Turning to FIGS. 25-26, shown is blending system 1500 having plug 1600. Blending system 1500 may be similar or the same as first blending system 10 and/or second blending system 1000. For example, blending system 1500 may include a blending cup 100 selectively attached to a motor base 200. Although blending cup 100 and the internal components of motor base 200 may not be specifically or completely shown in FIGS. 25-26, it is noted that general aspects, references and descriptions of the blending cup 100 and motor base 200 as described in reference to FIG. 1 and others, may be applied to the embodiments of FIGS. 25-26 unless context suggests or this description states otherwise.

Additionally, blending system 1500 and the embodiments of FIGS. 25-26 may incorporate any aspects, references and descriptions of second blending system 1000 as described in reference to FIGS. 21-24 and others, unless context suggests or this description states otherwise. For example, instead of channel 270 which can directly extend from the interior surface 220 of the motor base 200 to the exterior surface 230 of the motor base 200, blending system 1500 may incorporate a channel the same as or similar to channel 1070 of blending system 1000, such as including a two-part channel that can minimize the area needed to be plugged between open and closed positions and that may increase the ease and success of sealing during processing or blending.

In an embodiment, all other aspects of blending container 100 and motor base 200 as described in reference to FIG. 1 and others, except the removability of the plug for cleaning, may be the same between the first blending system 10 and this blending system 1500. In an embodiment, all other aspects of second blending system 1000 as described in reference to FIG. 25 and others, except the removability of the plug for cleaning, may be the same between the second blending system 1000 and this blending system 1500. Moreover, the removability of the plug, or the like, may be incorporated into any of FIGS. 1-24, into the first blending system 10, into the second blending system 1000, and into any of the embodiments including plugs 300, 400, 500, 600, 700, 800, 900, 1100.

Shown in FIGS. 25-26 is a ninth plug 1600, which may be similar to plug 800, except that the sipping mechanism may be isolated and contained in removable-tube mechanism 1600. The removable-tube mechanism 1600 may allow for enhanced clean-ability and may be automatically cleaned, submerged fully in water, put through a dishwasher, etc., without need for preserving or isolating internal batteries or electrical components. In embodiments where the sipping mechanism is integral to the motor base 200, the sipping mechanism may not be able to be automatically cleaned, submerged fully in water, put through a dishwasher, etc. because the motor base (e.g., 200) may include a power source or batteries that restrict the motor base (e.g., 200) in terms of contact with water. The cleaned parts can be assembled back together by pushing in the removable tube-mechanism 1600 into the motor base 200. A latch or the like can secure the removable tube-mechanism 1600 into place. In embodiments where the removable tube-mechanism 1600 may be isolated and removed from the motor base (e.g., 200) or where the sipping or sealing mechanism is contained solely within the plug, there may be no need to mount onto the motor base (e.g., 200) or disturb the fully sealed motor base assembly (e.g., 200).

For example, ninth plug 1600 may include a first lid 1610 and a trap door 1620, and may include a channel 1670 and body 1672 which inserts into the channel 270 of the motor base 200, for example. In an embodiment, the first lid 1610 may be a hinged top closure. In an embodiment, the trap door 1620 may be a hinged bottom closure. It is noted that the top closure and the bottom closure may include engagement or closure mechanisms other than being hinged, such as snap fit, friction fit, etc. In an embodiment, the hinged top closure and hinged bottom closure are linked so that transitioning the hinged top closure to the open position causes the hinged bottom closure to open, and transitioning the hinged top closure to the closed position causes the hinged bottom closure to close. The first lid 1610 may selectively cover and seal an opening 1632 at the exterior side 230 of the motor base 200. The trap door 1620 may selectively cover and seal an opening 1622 at the interior side 220 of the motor base 100. Unlike plug 800, the channel 270 may be fully occupied by plug 1600 since plug 1600 includes its own separate drinking channel 1670 that is different from channel 270, used in this embodiment as a channel 270 configured to receive plug 1600.

Aside from the isolated or self-contained channel 1670 (and/or isolated or self-contained linkage) different from channel 270 in regard to plug 800, any or all other aspects from plug 800 may be incorporated or applied to plug 1600. For example, the first lid 1610 may be on a hinge 1612 and may include lip 1614 for ease of opening. Once opened about the hinge 1612, first lid 1610 may open and a linkage 1630 between the first lid 1610 and a trap door 1620 may be released, thereby also opening the trap door 1620. When closed about the hinge 1612, first lid 1610 may close and a linkage 1630 between the first lid 1610 and a trap door 1620 may be pulled, thereby also closing the trap door 1620. The linkage 1630 may be housed within the body 1672 of the plug 1600 (rather than the housing of the motor base 200 as in regard to plug 800).

A user may open the first lid 1610 in the direction of Arrow ‘1.’ Linkage 1630 moves to the left, unlocking the trap door 1620 and then moves along the arrow ‘2’ and pulls up the right side of the trap door 1620. Trap door 1620 moves along the direction of arrow ‘3’ and opens the channel 1670 or the passage to sip or insert straw. The trap door 1620 pivots along the solid red cylinder/sphere that is press fitted into an opening in the side wall of the channel 270 or sipping tube. The plug 1600 may be fully removed from the motor base 200 and channel 270.

The plug 1600 or removable tube mechanisms can be cylindrical, crescent moon shaped, crescent shaped, or other shapes. Plug 1600 may be any material, such as different materials for food safety like stainless or copper for anti-microbial properties.

In an embodiment, plug 1600 may be held, locked, or secured in place into channel 270 by a turn-thread, such as a quarter turn-thread.

In an embodiment, plug 1600 may include a locking tab on the cup that would pivot over on top of the plug 1600 to hold it into place.

In an embodiment, the compartment for the linkage 1630 may be sealed to keep foodstuff, water, and the like from entering the compartment, or the compartment with the linkage 1630 may be accessed and cleaned.

In an embodiment, the first lid 1610 and trap door 1620 may include seals to assist in sealing channel 1670 from foodstuff, water, and the like. In an embodiment, the seals may be O-ring seals or standard cylindrical seals. In an embodiment, the seals may be x-ring seals to release pressure in the event that someone tries to blend hot soup, etc.

In an embodiment, the first lid 1610 may be biased to be closed. In an embodiment, plug 1600 may include a spring or other biasing member, such as a magnet, that pulls the first lid 1610 closed. In an embodiment, after a certain point, such as when the first lid 1610 is ¾ the full way open, the bias may be overcome and the first lid 1610 will not snap down. In an embodiment, a nail-clipper like hinge may be used, where the first lid 1610 can be lifted and then spun into place to lock in an open position.

In an embodiment, the blending system 1500 may include one or more reed switches, such as three reed switches. For example, the blending system may include two reed switches on the motor-base-lip so when the cup is tightened sufficiently, these line up with magnets in the cup-lip and allow motor to run. The blending system may also include a third reed switch on the sipping mechanism. This will not allow the motor to start, or stop the motor if the sipping plug is not at the locked position. In an embodiment, the signals from all three reed switches may be read by a microcontroller to detect a state of all three reed switches and can turn integrated LEDs (or any other type of alert such as a beep or vibration) red (or any other desired color) if everything is not in place when the motor start button is pressed. It is noted that a magnetic latch may also be utilized.

In an embodiment, the drinking channel, e.g. 270, 1670, may be sealed at or near the external surface 230 of the motor base 200 and sealed at or near the internal surface 220 of the motor base 200. In an embodiment, due to this additional closure or seal at the internal surface 220 of the motor base 200, foodstuff may be prevented from entering the channel 270, 1670 during blending.

In reference to any or all the embodiments described herein, the interior surface 220 of the motor base 200 may generally define a surface that assists in flow of foodstuff within the cup 100 when blending foodstuff. In an example, the interior surface 220 may be curved, convex, concave, sloped, or otherwise angled to direct a first flow towards the blade assembly 260 and direct a second flow of foodstuff that has passed through a path of the blade assembly 260 away from the blade assembly 260 to create and continue flow path that forces foodstuff into the path of the blade assembly 260. In an example, the interior surface 220 may be generally a concave surface with a vertex coaxial with central axis A and extending into the housing 210 or towards the exterior surface 230.

It is further noted that the motor base 200 may provide a seal between the cup 100 and the housing 210 of the motor base 200. In an example, the sidewalls 240 of the motor base 200 may be friction fit with the sidewalls 130 of the cup 100. In another example, a sealing gasket (not shown), may be disposed between the open end 110 of the cup 100 and the apron 250. The gasket may comprise an elastomeric material that is compressible to form a liquid tight seal. In an embodiment, the cup 100 may be designed specifically for use with the motor base 200. As such, the cup 100 and the motor base 200 may comprise cooperating mating engagements, such as threaded members, bayonet-type locks, groove and channel locks, or the like. In an embodiment, the cup blender 200 may include an apron 250 that ratchets, clamps, clips, or otherwise tightens around a portion of a cup 100. Once tightened in an operative engagement, the apron 250 may sealingly engage the cup 100. The apron 250 may include a pressure release or opening mechanism that allows for built up pressure (e.g., such as due to a raise in temperature) to be released.

In an embodiment, the apron 250 may include one or more sensors to detect whether the cup 100 is sealingly engaged with the housing 210. If the sensors detect that the cup 100 is not sealingly engaged, the driver circuit 269 (in communication with one or more of the blade assembly 260, drive shaft 262, motor 264, power source 266, blades 268, etc.) may prevent or terminate operation of the motor, and/or generate error messages or warnings (e.g., via audio, video, tactile, or other forms of communication). In at least one example, the sensors may include pressure sensors, proximity sensors, optical sensors, or the like disposed on the apron 250 and/or on sidewall 240 of the motor base 200. The sensors may detect the presence or lack thereof of the cup 100. In at least one example, at least two sensors may be spaced apart from each other. In another example, at least three sensors are spaced out from each other. If less than all of the sensors detect the cup 100, the driver circuit 269 may prevent or cease operation of the motor.

Further, the cup 100 and the motor base 200 may include wireless or wired actuator circuits that interact with each other to determine whether the cup 100 and the motor base 200 are operatively attached. For instance, the cup 100 and the motor base 200 may include NFC devices that may communicate with each other, magnetic sensors (e.g., a reed switch), tactile buttons and corresponding physical actuators, or the like. As an example, cup 100 may be able to detect the motor base 200 or vice versa. If the motor base 200 is not in place, e.g. is not engaged with the cup 100 or sealingly engaged, the driver circuit 269 may not drive the blade assembly. Such detection can be accomplished by magnetic/Reed switch, momentary switch, IR sensor, etc. This can prevent activation of the motor or blade assembly when the motor base 200 is not inserted into the cup 100 or when the motor base 200 may be at risk of becoming disengaged from the cup 100 during blending.

In an embodiment, sensors may be incorporated and used to detect whether the plug 300, 400, 500, 600, 700, is in an open or closed position. If the sensors detect that the plug 300, 400, 500, 600, 700 is in an open position, the driver circuit 269 (in communication with one or more of the blade assembly 260, drive shaft 262, motor 264, power source 266, blades 268, etc.) may prevent or terminate operation of the motor, and/or generate error messages or warnings (e.g., via audio, video, tactile, or other forms of communication). In at least one example, the sensors may include pressure sensors, proximity sensors, optical sensors, or the like disposed within or at the motor base 200, the channel 270, at first opening 222, at second opening 232, and/or on the plug 300, 400, 500, 600, 700, such as on the arm of the plug (e.g. 320) or another surface of the plug (e.g. top surface 310 of the plug, first mating feature 314, and the like). The sensors may detect the presence, position or orientation of the plug 300, 400, 500, 600, 700. In at least one example, at least two sensors may be spaced apart from each other. In another example, at least three sensors are spaced out from each other. If less than all of the sensors detect the plug 300, 400, 500, 600, 700, the driver circuit 269 may prevent or cease operation of the motor.

In an example, turning to FIGS. 3A-3B, one or more sensors 279 may be disposed with the channel 270 (e.g., such as the sipping pathway 276 and/or the plug receptacle 274), the motor base 200, and/or the plug 300. A tactile or magnetic sensor 279 may detect the absence or presence of the plug 300 in one or more of the open positions or the closed positions. If the sensor 279 detects that the plug 300 is not in the closed position, the driver circuit 269 may prevent operation of the motor 264. Sliding the plug 300 to the fully closed positon, may allow the sensor to detect the plug 300 and the driver circuit 269 may then allow operation of the motor 264. It is noted that the driver circuit 269 may further require detection of the cup 100 properly secured to the motor base 200 while the plug 300 is properly in the closed position before the motor 264 can operate. If the cup 100 becomes detached or not secured and/or the plug 300 becomes detached or not secured, the driver circuit 269 may cause the motor 264 to stop driving the blade assembly 260. It is noted that such description of sensors 279 is applicable to any of the described plugs and embodiments herein. It is also noted that the position of the sensors 279 shown in FIGS. 3A-3B is not exhaustive and the sensors 279 may be placed in other positions as desired.

As another example, turning to FIG. 18 one or more sensors 279 may be disposed with the channel 270, the motor base 200, and/or the plug 800. A tactile or magnetic sensor 279 may detect the absence or presence of the plug 800 in one or more of the open positions or the closed positions. If the sensor 279 detects that the plug 800 is not in the closed position, the driver circuit 269 may prevent operation of the motor 264. Moving the plug 800 to the fully closed positon, may allow the sensor to detect the plug 800 and the driver circuit 269 may then allow operation of the motor 264. It is noted that the driver circuit 269 may further require detection of the cup 100 properly secured to the motor base 200 while the plug 800 is properly in the closed position before the motor 264 can operate. If the cup 100 becomes detached or not secured and/or the plug 800 becomes detached or not secured, the driver circuit 269 may cause the motor 264 to stop driving the blade assembly 260. It is noted that such description of sensors 279 is applicable to any of the described plugs and embodiments herein. It is also noted that the position of the sensors 279 shown in FIG. 18 is not exhaustive and the sensors 279 may be placed in other positions as desired.

In at least one embodiment, the pathway may include a flow meter, IR or optical sensor, thermal sensor, or other sensor that detects the presence of foreign material (e.g., food stuff, straw, appendage, etc.) within the pathway. If a foreign object is detected, the flow meter, IR or optical sensor, thermal sensor, or other sensor may communicate with the driver circuit 269 to prevent operation of the motor.

Further, the channel 270 and the plug 300, 400, 500, 600, 700 may include wireless or wired actuator circuits that interact with each other to determine whether the plug is in an open or closed position. For instance, the channel 270 and the plug 300, 400, 500, 600, 700 may include NFC devices that may communicate with each other, magnetic sensors (e.g., a reed switch), tactile buttons and corresponding physical actuators, or the like. As an example, the motor base 200 may be able to detect the plug 300, 400, 500, 600, 700 or vice versa. If the plug 300, 400, 500, 600, 700 is not in place, e.g. is not in a closed position or in a fully closed position, the driver circuit 269 may not drive the blade assembly. Such detection can be accomplished by magnetic/Reed switch, momentary switch, IR sensor, etc. This can prevent activation of the motor or blade assembly when a user is drinking, has a straw through the motor base 200, etc.

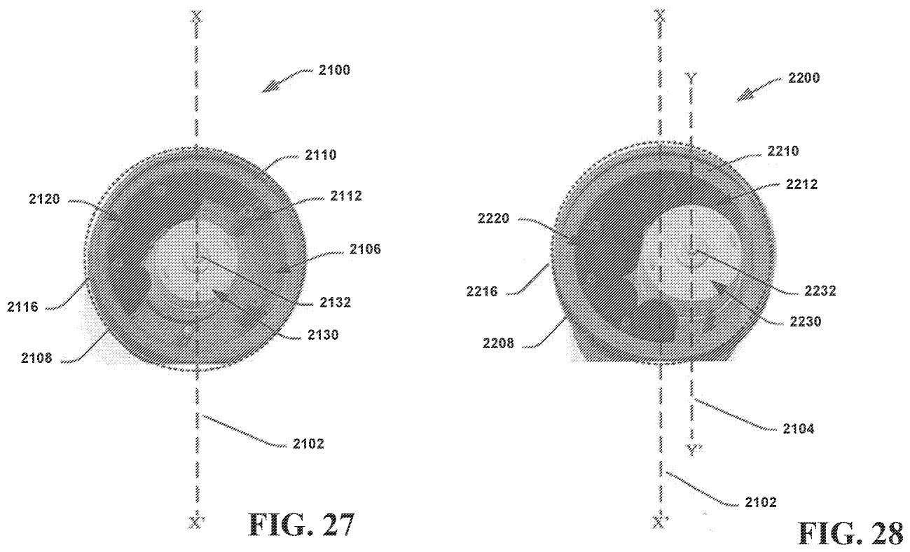

Turning to FIGS. 27-38, shown is an embodiment of a cup blender and blending system that is asymmetric. The cup blender and blending system that may be used with or incorporate a sipping mechanism as described herein or the cup blender and blending system may not include a sipping mechanism. For example, any or all aspects of prior described embodiments of FIGS. 1-26, the first blending system 10, the second blending system 1000, blending system 1500, and any of the embodiments including plugs 300, 400, 500, 600, 700, 800, 900, 1100, 1600 may include the asymmetric orientation as described in reference to the cup blender of FIGS. 27-38. Moreover, the asymmetric orientation of FIGS. 27-38 and the cup blender as herein described, or the like, may be incorporated into any of FIGS. 1-26, into the first blending system 10, into the second blending system 1000, into blending system 1500, and into any of the embodiments including plugs 300, 400, 500, 600, 700, 800, 900, 1100, 1600.

In an embodiment, the cup blender and blending system may be asymmetric. For example, a blade assembly may be driven by a motor that is powered by a power source. The power source and the motor may be disposed within a body of, for example, the motor base (such as the motor base described in reference to FIGS. 1-24). The power source may be disposed next to the motor. The motor may include a central axis coaxial with a drive shaft. The body may include another axis. The axis of the body may be offset with the axis of the motor. The motor base may further include a channel, such as channels 270, 1070, and that extends from the external wall and to the internal wall, and that may allow access to an interior of the blending container when the motor base is selectively attached to the open end of the blending container. The motor base may further include a plug that selectively opens and closes the channel to allow selective access to or sealing of the interior of the blending container when the motor base is selectively attached to the open end of the blending container. The blending system may be portable.

Cup blenders have become more popular with advances in battery and battery management technology. However, traditional cup blenders are underpowered and underperforming. Size limitations contribute to such shortcomings as the available space for the batteries and a motor is often very limited. As such, some traditional cup blenders may fail in attempts to make smoothies or other thick products. For instance, energy requirements to blend smoothie ingredients can be quite high compared to energy requirements to mix powdered drinks. In another aspect, traditional cup blenders require large batteries that take up considerable space within a body of such cup blenders.

In described embodiments a power source (e.g., a battery, batteries, etc.) may be disposed on a side of a motor. When a power source is placed on the side of the motor, there is typically open space on the other side of the motor. As such, the diameter of the cup blender may remain relatively large such that suitable cups must also be relatively large. Moreover, traditionally, a top side of the cup blender incudes a blade assembly and a bottom side includes a driver circuit 269 board and a processor. As used herein, the term “top” refers to the side of a cup blender that includes a blade assembly and faces towards foodstuff when in use. The term “bottom” refers to the side of a cup blender opposed to the top. The term “side” refers to the side or side of the cup blender extending between the top and bottom. The side may be any shape but is often cylindrical or frustoconical.

In use, traditional cup blenders are inverted and placed at least partially in cups or drinking vessels. The top of the cup blender is first inserted into the cup such that the blade assembly is disposed within the cup. The cup radially circumscribes at least a portion of the side walls of the cup blender. The cup and blender may then be inverted again and the motor is activated.

Traditionally, smoothie cups range in size from 12 fluid ounces to 24 fluid ounces. As such, cup diameters are designed around human consumption and human hand sizes. If the cup diameter is too large for a person's hand it can make it very difficult for them to hold. The cup may further be too large and otherwise not fit into most cup holders. Such large cups are traditionally used with traditional cup blenders.

An example of a traditional system is shown in FIG. 27. A cup blender 2100 includes a body or housing 2110; internal chamber 2112, power source 2120, motor 2130 including a drive shaft 2132, central axis X-X 2102, and a diameter 2106. The housing 2110 defines the internal chamber 2112. The power source 2120 and the motor 2130 are disposed within the internal chamber 2112. The power source 2120 is disposed on the side of the motor (e.g., between the motor 2130 and a side wall 2116 of the housing 2110). The motor 2130 includes a drive shaft 2132 that is generally in line or coaxial with the central axis X-X′ 2102. The central axis X-X′ 2102 is central to the housing 2110. An empty or hollow space 2106 is created on the side of the motor 2130 where the power source 2120 is not disposed. In such systems the diameter 2108 of the side walls 2116 must be large enough to accommodate the motor 2130, the power source 2120, and the space 2106.

Turning to FIG. 28, there illustrated is a cup blender 2200 according to various disclosed embodiments. The cup blender 2200 primarily includes a body or housing 2210 defining an internal chamber 2212. The chamber 2212 houses a power source 2220 (e.g., disposable battery, rechargeable battery via a cable, kinetics, light, etc.) and a motor 2230 including a drive shaft 2232. As illustrated, the drive shaft axis Y-Y′ 2104 is offset of or otherwise not axial with a central axis X-X′ 2102 of the housing 2210. On this arrangement the diameter 208 of the side wall 2216 may be reduced in comparison to traditional cup blenders, such as cup blender 2100. In an example, the diameter 2208 may be reduced by between 10% to 30% relative diameter 2108, while the motor 2230 and motor 2130 remain the same or similar size, and the power source 2220 and 2120 remain the same or similar size. For example, the diameter 2208 may be about 3.25 inches, and the diameter 2108 may be about 3.94 inches. It is noted that chamber 2212 does not include an open space 2106.

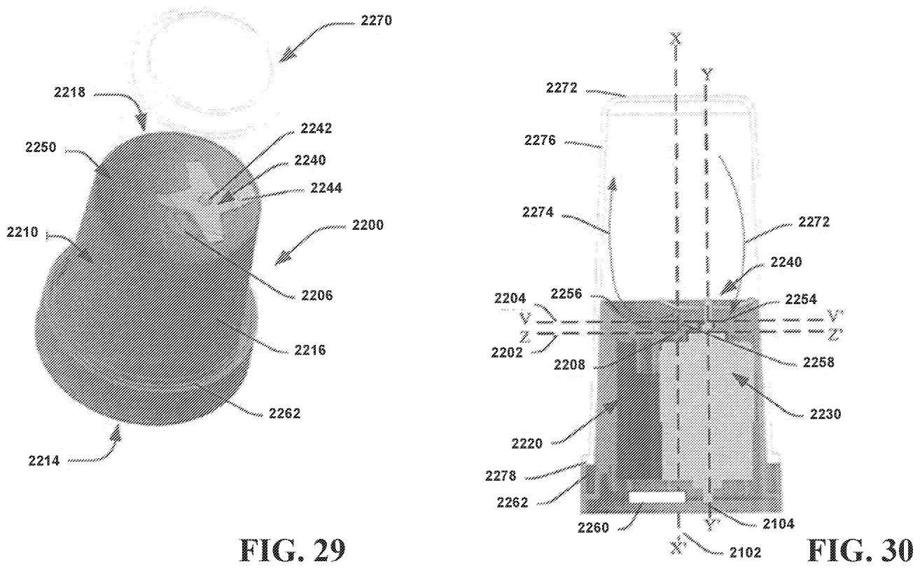

Turning to FIGS. 29 and 30, with reference to FIG. 28, there are a side perspective view and side cross-sectional view of the cup blender 2200 with a cup 2270 attached thereto. As described here and elsewhere in this disclosure, the drive shaft axis Y-Y′ 2104 is offset of or otherwise not axial with a central axis X-X′ 2102.

The housing 2210 generally includes the side wall, a top 2218 comprising a top surface 2250, and a bottom 2214, which may include a user interface 2260 communicatively coupled to or including a driver circuit 269. The housing 2210 may further include a lip or apron 2262 that extends from the side wall 2216 to form a ledge or stop for the cup 2270. The cup 2270 may include a closed end 2272, side wall 2276, and open end 2278. It is noted that the housing 2210 and cup 2270 may comprise various shapes, sizes, and materials. In an example, the housing 2210 and the cup 2270 may include plastics, metal, glass, natural materials, or other food grade material.

A blade assembly 2244 may extend from the top surface 2250. The blade assembly 2240 may include a drive shaft 2242 which may be driven by motor 2230 and coaxial to drive shaft 2232 of the motor 2230. In some examples, the drive shaft 2232 and the drive shaft 2242 may be the same drive shaft. The blade assembly 2240 may include one or more blades 2244 extending from the drive shaft 2242. While blades 2244 are described, it is noted that other mixing devices may be utilized, such as frothers, whisks, or the like.

The top surface 2250 may generally define a surface that assists in flow 2272/2274 of foodstuff within the cup 2270 when blending foodstuff. In an example, the top surface 2250 may be curved, convex, concave, sloped, or otherwise angled to direct the flow 2272 towards the blade assembly 2240 and direct the flow 2274 of foodstuff that has passed through a path of the blade assembly 2240 away from the blade assembly 2240 to create a flow path that forces foodstuff into the path of the blade assembly 2240. In an example, the top surface 2250 may be generally a concave surface 2256 with a vertex coaxial with central axis X-X′ 2102 and directed towards the cavity 2212. The vertex may be tangential to horizontal axis Z-Z 2202.

In at least one embodiment, a portion of the top surface may be raised where the drive shaft 2242 extends from the top surface 2250. For example, protrusion 2206 may extend from the top surface 2250. In at least one example, the protrusion 2206 may extend from the vertex 2208 via a sloped, convex, concave or otherwise angled surface 2258 to a planar surface 2254 that is coplanar with a horizontal axis V-V′ 2204. It is noted that the horizontal axis V-V′ 2204 and horizontal axis Z-Z′ 2202 are not coplanar, such that horizontal axis V-V′ 2204 is closer further from the bottom 2214. In another aspect, the planar surface 2254 may be generally below the blades 2244 of the blade assembly. As such, foodstuff may be drawn into the blades 2244 via a lifting force and forced down the angled surface 2258. The foodstuff is then forced along the concave surface 2256 and towards the walls 2276 or closed end 2272 of the cup 2270. The offset of the central axis X-X′ 2102 from the drive shaft axis Y-Y′ 2104 in combination with the offset of the horizontal axis V-V′ 2204 from horizontal axis Z-Z′ may provide improved blending.

It is further noted that the cup blender 2200 may provide a seal between the cup 2270 and the housing 2210. In an example, the walls 2216 may be friction fit with the walls 2276 of the cup. In another example, a sealing gasket (not shown), may be disposed between the open end 2278 of the cup 2270 and the apron 2262. The gasket may comprise an elastomeric material that is compressible to form a liquid tight seal.

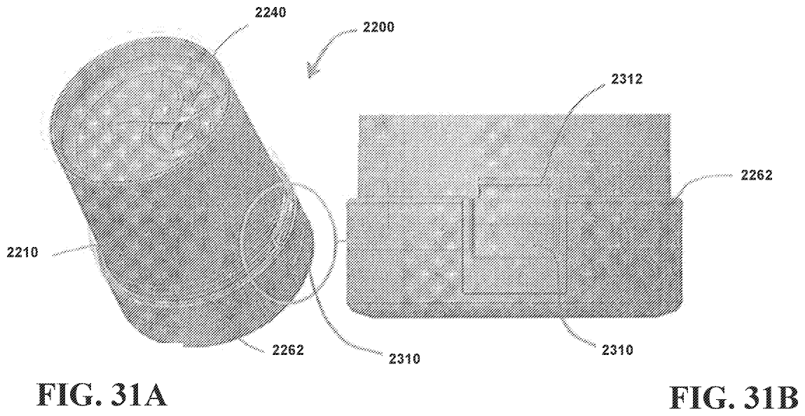

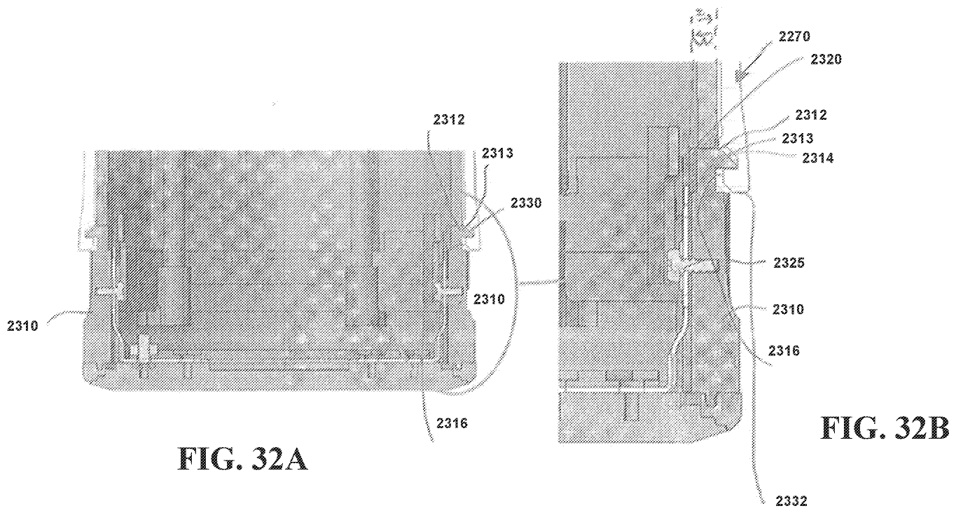

Turning to FIGS. 31 and 32, there are a side perspective view of the cup blender 2200 and a side cross-sectional view of the cup blender 2200 wherein a resilient attachment mechanism 2310 is further included in the housing 2210. The resilient attachment mechanism 2310 includes a top portion 2312 which includes an engagement mechanism 2313 that can protrude outwardly towards the cup 2270 as shown in FIG. 32 or can be reversed to protrude inwardly towards the base 2210. In the embodiment as shown in FIG. 32, the engagement mechanism 2313 protrudes outwardly, away from the base 2210 and towards the cup 2270. The top portion 2312 of the resilient attachment mechanism 2310 can further include a tapered or angled portion 2314 as shown in FIG. 32. The cup 2270 can include an interior recess 2330 around a full or partial circumference of the interior portion of the cup 2270. The interior recess 2330 is spaced a distance from the base of the cup 2332 such that the base of the cup 2332, when placed over the housing 2210, will extend past the top portion of the engagement mechanism 2312 and permit the engagement mechanism 2313 to attachably and releasably engage with the interior recess 2330 of the cup 2270 as shown in FIG. 32. The resilient attachment mechanism 2310 can be attached to the housing 2210 by attachment means 2325.

As shown in the drawings, attachment means 2325 is a screw-type securement mechanism. However, it is understood that other types of attachment means could be used such as an adhesive construction, including, by way of example, adhesive coated foam tapes for example. Non-adhesive attachment means can also be used as well as a combination of mechanical and adhesive based attachment mechanisms to attach the resilient attachment mechanism 2310 to the housing 2210. A compression recess 2320 is formed in the housing 2210 to allow for compression of the engagement mechanism 2313 towards the housing 2210 by application of a force to the resilient attachment mechanism 2310 in a direction towards the housing 2210. The application of a force to the resilient attachment mechanism 2310 in a direction towards the housing 2210 will be sufficient to compress engagement mechanism 2313 into compression recess 2330 in a direction “w” such that engagement mechanism 2313 disengages from interior recess 2330 of cup 2270 thereby allowing cup 2270 to become removable from housing 2210.

Removal of the force on resilient attachment mechanism 2310 will allow the engagement mechanism 2313 to move in a direction “z” and return to a non-compressed position. In operation, a user can place cup 2270 over housing 2210 and insert housing 2210 into cup 2270 to a point such that engagement mechanism 2313 contacts the base of the cup 2332 on the angled portion 2314 of the engagement mechanism 2313. As the housing 2210 continues to be pushed into the cup 2270, the engagement mechanism 2313 is compressed into the housing 2210 up to the point of the interior recess 2330 of the cup 2270 wherein the engagement mechanism 2313, which is no longer in communication with the cup 2270, “snaps” into the interior recess 2330 of the cup 2270. The interior recess 2330 of the cup 2270 is sized to receive the engagement mechanism 2313 so that a sealed, secure and tight fit is accomplished when the housing 2210 is fully inserted into the cup 2270. To remove the cup 2270 from the housing 2210, the user applies a force to the resilient attachment mechanism 2310 in a direction “w” such that the engagement mechanism 2313 is moved in a direction “w” into the compression recess 2330 thereby disengaging cup 2270 from the housing 2210 and allowing the user to separate the cup 2270 from the housing 2210. Release of the force being applied to resilient attachment mechanism 2310 by the user allows the engagement mechanism 2313 to move in a direction “z” and return to an engageable position for future use. It is envisioned that one or more resilient attachment mechanisms 2310 can be included around the perimeter of the housing 2210. In FIG. 32, as a non-limiting example, two resilient attachment mechanisms 2310 are shown in diametrically opposed positions on the housing 2210.

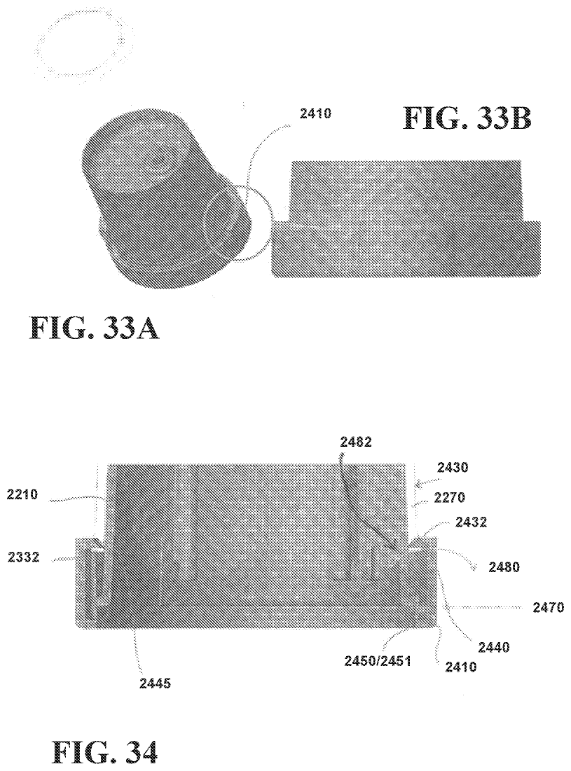

In an alternative embodiment, shown in FIG. 33 and FIG. 34, the resilient attachment mechanism for external cup surface engagement 2410 may be configured to engage with the external surface 2430 of the cup 2270. In such an arrangement, the external surface 2430 of the cup 2270 is configured to include an external recess or groove 2432 similar to the interior recess 2330 of cup 2270. Another aspect may include an external ledge on the cup 2270 which may also cooperatively work with the resilient attachment mechanism for external cup surface engagement 2410 to engage with and hold the cup 2270 to the housing 2210. The external recess 2432 can be formed around the full perimeter of the cup 2270 or partially around the perimeter. The resilient attachment mechanism for external cup surface engagement 2410 attaches to the housing 2210 by use of a fulcrum type connection 2450 such that when a force is applied in the direction “w” 2470 to the resilient attachment mechanism for external cup surface engagement 2410, the corresponding external engagement mechanism 2440, similar to element 2313 but facing towards the housing 2210, moves in direction “z” 2480 to cause the external engagement mechanism 2440 to disengage from the external recess 2432 in the cup 2270. A resilient compression component 2451, such as a spring or foam as non-limiting examples, can be included as the fulcrum 2450 between the resilient attachment mechanism for external engagement 2410 and the housing 2210. The resilient compression component 2451 will compress when a force is applied in direction “w” 2470, thereby moving the engagement mechanism in direction “z” 2480 and away from the external recess 2432 of the cup 2270.

Upon release of the force “w” the resilient compression component 2451 returns to its uncompressed state thereby causing the external engagement mechanism 2440 to move in direction “y” 2482 up to the point of engagement with the housing 2210 when a cup 2270 is not present. In operation, a user can place cup 2270 over housing 2210 and insert housing 2210 into cup 2270 to the point such that the external engagement mechanism 2440, which can have an angled surface 2445, comes into contact with the base of the cup 2332. As the housing 2210 continues to be pushed into the cup 2270, the external engagement mechanism 2440 moves in direction “z” 2480, thereby compressing the compression component 2451, wherein the base of the cup 2332 moves up to a point wherein the exterior engagement mechanism 2440 “snaps” into the exterior recess 2432 in cup 2270 as a result of the return of the compression component into an uncompressed state. The external recess 2432 of the cup 2270 is sized to receive the external engagement mechanism 2440 so that a sealed, secure and tight fit is accomplished when the housing 2210 is fully inserted into the cup 2270. As in the discussion for FIG. 32, it is envisioned that one or more resilient attachment mechanisms for external cup surface engagement 2410 may be included around the perimeter of the housing 2210.

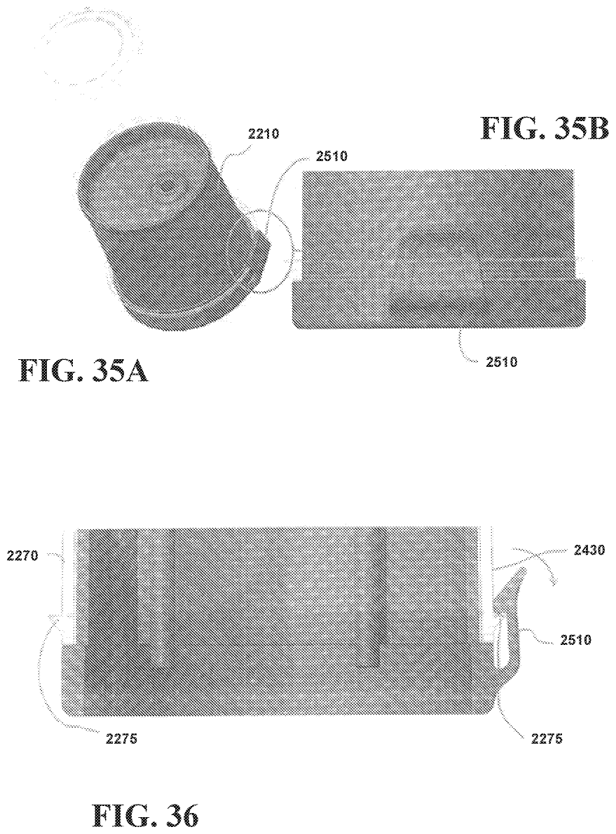

In further embodiments, latches can be used substantially as shown in FIGS. 35-38. Descriptions for these types of latches, and latches similar to these, can be found in, for example, U.S. Pat. Nos. 10,051,998, 9,635,981, U.S. D818,765 and U.S. D863,873, all of which have disclosures which are incorporated herein by reference. In a non-limiting embodiment, as shown in FIGS. 35 and 36, housing 2210 may include a resilient housing locking or latching device 2510. As depicted, housing latching device 2510 may include at least one U-shaped latch that creates a generally flushed seal with the blending container 2270, and connects along an external surface of the cup 2430. In an aspect, the housing latching device 2510 may secure the housing 2210 on the cup 2270). While a housing latch 2510 is described, it is noted that housing latch 2510 may include various other configurations, as described in more detail below. For example, housing latch 2510 may include a threaded member, a magnetic member, a channel locking member, or the likes. In another aspect, housing 2210 may include various different latching devices and various numbers of latching devices.

Housing latching device 2510 may be monolithically formed with housing 2210 or may be attached (e.g., removably or irremovably) to the housing 2210 through a subsequent operation. The housing latching device 2510 may be positioned on the housing 2210 in a fixed position to allow for the bottom of the housing latching device 2510 to operatively engage the external cup ledge 2275. The housing latching device 2510 may be a substantially hook-shaped latch to selectively attach the housing 2210 with the cup 2270. In an aspect, the housing latching device 2510 may prevent the housing 2210 from separating from the cup 2270, maintain a seal, and/or may reduce vibration of the cup 2270 during operation of the blending system.

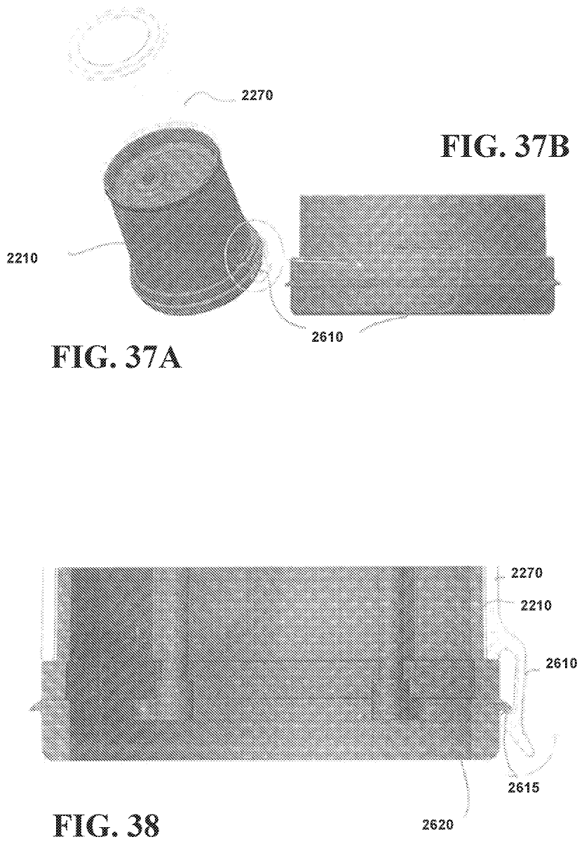

In another aspect, as shown in FIGS. 37 and 38, a resilient cup latch 2610 may be included on cup 2270 and be configured via cup latch ledge 2615 to engage with housing 2210 at housing ledge 2620.

It is further noted that the housing 2210 may be dishwasher safe, such as hermetically sealed to prevent foodstuff or liquid from entering into the cavity 2212 and interacting with the power source 2220, motor, 2230, driver circuit 269, or other operative elements.

In some embodiments, the apron 2262 may include one or more sensors to detect whether the cup 2270 is sealingly engaged with the housing 2210. If the sensors detect that the cup 2270 is not sealingly engaged, the driver circuit 269 may prevent or terminate operation of the motor 2230, and/or generate error messages or warnings (e.g., via audio, video, tactile, or other forms of communication). In at least one example, the sensors may include pressure sensors, proximity sensors, optical sensors, or the like disposed on the apron 2262 and/or on side wall 2216. The sensors may detect the presence or lack thereof of the cup 2270. In at least one example, at least two sensors may be spaced apart from each other. In another example, at least three sensors are spaced out from each other. If less than all of the sensors detect the cup 2270, the driver circuit 269 may prevent or cease operation of the motor 2230.

In another example, the cup 2270 may be designed specifically for use with the cup blender 2200. As such, the cup 2270 and the cup blender 2200 may comprise cooperating mating engagements, such as threaded members, bayonet-type locks, groove and channel locks, or the like. In other embodiments, the latching mechanism may comprise a paddle latch, draw latch with or without safety catch, a pivoting handle latch, a strikeless draw latch with or without safety catch, cam latch, or the like. The latches may also be removable. As an example of a removable latch, a strap with one or more clips that hold the base and cup securely together can be used. Other types of removable latches can also be incorporated with the ultimate goal of securely attaching the cup to the base. Further, the cup 2270 and the cup blender 2200 may include wireless or wired actuator circuits that interact with each other to determine whether the cup 2270 and the cup blender 2200 are operatively attached. For instance, the cup 2270 and cup blender 2200 may include NFC devices that may communicate with each other, magnetic sensors (e.g., a reed switch), tactile buttons and corresponding physical actuators, or the like.

In at least one example, the cup blender 2200 may include an apron 2262 that ratchets, clamps, clips, or otherwise tightens around a portion of a cup 2270. Once tightened in an operative engagement, the apron 2262 may sealingly engage the cup 2270. The apron 2262 may include a pressure release or opening mechanism that allows for built up pressure (e.g., such as due to a raise in temperature) to be released.

While embodiments may describe a power source (e.g. 266, 2220) disposed on the side of a motor (e.g., 264, 2230), it is noted that embodiments may include a power source located at other positions. For instance, the power source may be disposed near the top or the bottom of a body. In such examples, circuitry (e.g., driver circuit 269, user interface, etc.) may be disposed on the side of a motor. This may allow to maintain a reduced dimeter of the motor base and reduced sizes of cups with which the cup blender may be utilized. In an embodiment, circuitry and a power source may be disposed on the side of the motor. In other embodiments, the space next to the motor resulting from offsetting the drive axis of the motor with a central axis of a body may be generally filled with or otherwise contain any operative elements of the motor base or cup blender.

In an embodiment, the cup 100 may be generally cylindrical, conical, or frustoconical, the closed end or open end generally circular (e.g. having a general circumference), and the sidewall(s) generally curved or round. It is also noted, however, that the blending container 100 may generally comprise any size and shape as desired, including round, square, rectangular, irregular, or the like. Additionally, the cup 100 may comprise multiple shapes, for example the closed end or open end generally circular while the sidewall(s) are squared. It is noted that terms such as circumference, diameter, etc., while including round, circular, and cylindrical shapes, may also refer to the periphery or general aspects of a non-circular or round shape, such as a squared shape.

Further, unless context suggest otherwise, descriptions of shapes (e.g., circular, rectangular, squared, triangular, etc.) and the nature of the shapes (e.g., straight, curved, rounded, etc.) refer to shapes meeting the definition of such shapes and general representation of such shapes. For instance, a triangular shape or generally triangular shape may include a shape that has three sides and three vertices or a shape that generally represents a triangle, such as a shape having three major sides that may or may not have straight edges, triangular like shapes with rounded vertices, etc. Additionally, as used herein, the word near may be used to describe an aspect that is directly adjacent to or at another aspect, relatively close to another aspect, that is within 1-3 cm.

Moreover, a sidewall may have any number of sides, such as 1, 2, 3, 4, 5, 6, 7, 8, 9, 10, etc. sides, and may generally adopt the shape of a parallelogram, circle, rectangle, square, portion of any of the foregoing, or the like. As described herein, the sidewall(s) may include any number of flutes, such as flutes 150, 250. A sidewall or sidewalls, although encompassing a cavity therein, may also be referred to in a singular form or a plural form. Edges and corners of sidewall(s), or portions connecting sidewall(s), may similarly have any number of sides, such as 1, 2, 3, 4, 5, 6, 7, 8, 9, 10, etc. sides, and may generally adopt the shape of a parallelogram, circle, rectangle, square, portion of any of the foregoing, or the like. Although general measurements or indications of height, length, width, distance, thickness, and angles may be disclosed, it is noted that these aspects are broadly defined within this disclosure unless specifically indicated for a particular embodiment.

It is further noted that the housing 210 of the motor base 100 may be dishwasher safe, such as hermetically sealed to prevent foodstuff or liquid from entering into the cavity and interacting with the power source, motor, driver circuit 269, or other operative elements. It is further noted that any of the plugs described herein may be selectively removable from the motor base.

Any of the plugs described herein may comprise food safe material, such as a food grade plastic or metal. The plugs may include one or more gaskets that may be compressed when in an open or closed position to seal the pathway or other components.

In an embodiment, the cup 100 may be blow-molded. In an embodiment, the cup 100 may be blow-molded triton. The blending cups may also be injection-molded, etc., and may include any desirable plastic or material as may be used in the art.

Additionally, it is noted that the holding capacity for the cup, e.g. 100, disclosed herein may vary and may include any amount from 4 oz. to 60 oz., for example. The cup, e.g. 100, may be single serving, such as 8 oz. or may be single serving, but sized larger (such as for water bottles, protein shakes, and the like), including up to (or over) 128 oz. The cup 100 may be 32 oz., 40 oz., 48, oz. etc. The cup 100 may be used in commercial applications and may include larger holding capacities not explicitly listed.

In an aspect, described is a blender comprising a housing comprising a motor: a cup with a closed end and an open end, wherein the cup is attachable to the housing at the open end of the cup; wherein the housing comprises: an external wall, an internal wall, and at least one sidewall, wherein the motor is disposed between the external wall and the internal wall and within the at least one sidewall, wherein a surface of the internal wall includes a mixing blade extending therefrom and coupled to the motor through a drive shaft, a sipping pathway extending from the internal wall to the external wall, and an elongated plug extending from the internal wall to the external wall and operatively sealing the sipping pathway when in a closed position and allowing flow of material through the sipping pathway when in an open position.

In a second aspect, together with the above aspect, described here, wherein plug comprises one or more tracks or rails to engage with the housing and to transition between the closed position and the open position.

Any one or more of the above aspects, wherein the plug is slidable from a first position on an outer circumference of the housing to a second position on the outer circumference of the housing to transition between the closed position and the open position.

Any one or more of the above aspects, wherein the plug is rotatable about an axis defined by the sipping pathway to transition between the closed position and the open position.

Any one or more of the above aspects, wherein the internal wall covers at least a portion of the plug when the plug is in the open position.

Any one or more of the above aspects, wherein the plug inserts into a plug receptacle in the housing in the open position and wherein the plug receptacle is sealed from the cup in the closed position.

Any one or more of the above aspects, wherein the plug further comprises a tab extending from plug wherein force applied to the tab moves the plug from the closed position and the open position.

Any one or more of the above aspects, wherein the housing further comprises an apron that extends from the at least one side wall at or near the external wall, wherein the apron attaches with the open end of the cup.

Any one or more of the above aspects, wherein the housing further comprises a battery disposed between the external wall and the internal wall and within the at least one sidewall, wherein at least one of the battery, the mixing blade, the drive shaft, and the motor are offset from a central axis of the housing, wherein the central axis is defined by the internal wall and the external wall.

Any one or more of the above aspects, further comprising at least one magnet pair in the housing to bias the plug towards the closed position.

Any one or more of the above aspects, wherein the plug is removable from the housing.

Any one or more of the above aspects, wherein an exterior surface of the exterior wall comprises a user interface that receives input to operatively control operation of the motor and blade assembly.

Any one or more of the above aspects, comprising a blender comprising a cup with a closed end and an open end: a motor housing comprising an interior end that is insertable into the open end of the cup and a sipping pathway extending through the motor housing to an exterior end: a plug operatively closing the sipping pathway at both the interior end and the exterior end of the motor housing: wherein the motor housing comprises a motor disposed in the motor housing and includes a mixing blade on the interior end, wherein the mixing blade is coupled to the motor through a drive shaft, wherein the mixing blade, the drive shaft, and the motor are offset from a central axis of the motor housing.

Any one or more of the above aspects, wherein the motor housing further comprises a battery and the battery is offset from the central axis of the motor housing.

Any one or more of the above aspects, wherein the plug comprises a hinged top closure and a hinged bottom closure to transition between a closed position and an open position.

Any one or more of the above aspects, wherein the hinged top closure and hinged bottom closure are linked so that transitioning the hinged top closure to the open position causes the hinged bottom closure to open and transitioning the hinged top closure to the closed position causes the hinged bottom closure to close.

Any one or more of the above aspects, including a blender comprising a cup with a closed end and an open end, and a motor housing with an interior end and an exterior end, wherein the interior end is insertable into the open end of the cup and wherein the exterior end is attachable to the open end of the cup, herein the motor housing comprises a motor and a battery disposed within the motor housing, wherein the motor housing further comprises a mixing blade on the interior end and coupled to the motor through a drive shaft, wherein the mixing blade, the drive shaft, the battery, and the motor are offset from a central axis of the motor housing, wherein the motor housing further comprises a sipping pathway extending from the internal end to the external end and a plug, wherein the plug is operatively moveable between a closed position within the sipping pathway and an open position within a cavity of the motor housing.

Any one or more of the above aspects, further comprising a first at least one sensor that detects the presence of the cup in an attached position.

Any one or more of the above aspects, further comprising a second at least one sensor that detects the presence of the plug in at least the closed position.

Any one or more of the above aspects, further comprising a drive circuit that prevents operation of the motor when the first at least one sensor does not detect the cup in the attached position or the second at least one sensor does not detect the plug in the closed position.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A blender, comprising:
a housing comprising a motor; and
a cup with a closed end and an open end, wherein the cup is attachable to the housing at the open end of the cup;
wherein the housing comprises:
an external wall, an internal wall, and at least one sidewall, wherein the motor is disposed between the external wall and the internal wall and within the at least one sidewall, wherein a surface of the internal wall includes a mixing blade extending therefrom and coupled to the motor through a drive shaft, and
a sipping pathway extending from the internal wall to the external wall, and an elongated plug extending from the internal wall to the external wall and operatively sealing the sipping pathway when in a closed position and allowing flow of material through the sipping pathway when in an open position.

2. The blender of claim 1, wherein the elongated plug comprises one or more tracks or rails to engage with the housing and to transition between the closed position and the open position.

3. The blender of claim 2, wherein the elongated plug is slidable from a first position on an outer circumference of the housing to a second position on the outer circumference of the housing to transition between the closed position and the open position.

4. The blender of claim 2, wherein the elongated plug is rotatable about an axis defined by the sipping pathway to transition between the closed position and the open position.

5. The blender of claim 1, wherein the internal wall covers at least a portion of the elongated plug when the elongated plug is in the open position.

6. The blender of claim 1, wherein the elongated plug is insertable into a plug receptacle in the housing in the open position and wherein the plug receptacle is sealed from the cup in the closed position.

7. The blender of claim 1, wherein the elongated plug further comprises a tab extending from plug wherein force applied to the tab moves the plug from the closed position and the open position.

8. The blender of claim 1, wherein the housing further comprises an apron that extends from the at least one sidewall at or near the external wall, wherein the apron attaches with the open end of the cup.

9. The blender of claim 1, wherein the housing further comprises a battery disposed between the external wall and the internal wall and within the at least one sidewall, wherein at least one of the battery, the mixing blade, the drive shaft, and the motor are offset from a central axis of the housing, wherein the central axis is defined by the internal wall and the external wall.

10. The blender of claim 1 further comprising at least one magnet pair in the housing to bias the elongated plug towards the closed position.

11. The blender of claim 1, wherein the elongated plug is removable from the housing.

12. The blender of claim 1, wherein an exterior surface of the external wall comprises a user interface that receives input to operatively control operation of the motor and blade assembly.

13. A blender, comprising:
a cup with a closed end and an open end;
a motor housing comprising an interior end that is insertable into the open end of the cup and a sipping pathway extending through the motor housing to an exterior end; and
a plug operatively closing the sipping pathway at both the interior end and the exterior end of the motor housing;
wherein the motor housing comprises a motor disposed in the motor housing and includes a mixing blade on the interior end, wherein the mixing blade is coupled to the motor through a drive shaft, and
wherein the mixing blade, the drive shaft, and the motor are offset from a central axis of the motor housing.

14. The blender of claim 13, wherein the motor housing further comprises a battery and the battery is offset from the central axis of the motor housing.

15. The blender of claim 13, wherein the plug comprises a hinged top closure and a hinged bottom closure to transition between a closed position and an open position.

16. The blender of claim 15, wherein the hinged top closure and the hinged bottom closure are linked so that transitioning the hinged top closure to the open position causes the hinged bottom closure to open and transitioning the hinged top closure to the closed position causes the hinged bottom closure to close.

17. A blender, comprising:
a cup with a closed end and an open end; and
a motor housing with an interior end and an exterior end, wherein the interior end is insertable into the open end of the cup and wherein the exterior end is attachable to the open end of the cup,
wherein the motor housing comprises a motor and a battery disposed within the motor housing, wherein the motor housing further comprises a mixing blade on the interior end and coupled to the motor through a drive shaft, wherein the mixing blade, the drive shaft, the battery, and the motor are offset from a central axis of the motor housing,
wherein the motor housing further comprises a sipping pathway extending from the interior end to the exterior end and a plug, and
wherein the plug is operatively moveable between a closed position within the sipping pathway and an open position within a cavity of the motor housing.

18. The blender of claim 17, further comprising at least one first sensor that detects a presence of the cup in an attached position.

19. The blender of claim 18, further comprising at least one second sensor that detects a presence of the plug in at least the closed position.

20. The blender of claim 19, further comprising a drive circuit that prevents operation of the motor when the at least one first sensor does not detect the cup in the attached position or the at least one second sensor does not detect the plug in the closed position.
